(19) United States
(12) Patent Application Publication
(10) Pub. No.: US 2026/0043889 A1
(43) Pub. Date: Feb. 12, 2026

(54) UTILIZING CELLULAR SIGNALS FOR DETERMINING DEVICE LOCATION

(71) Applicant: Google LLC, Mountain View, CA (US)

(72) Inventors: Ali ABDALLAH, Sunnyvale, CA (US); Etienne LE GRAND, Belmont, CA (US); Maria Jesus GARCIA PUYOL, La Cala del Mor (ES)

(73) Assignee: Google LLC, Mountain View, CA (US)

(21) Appl. No.: 19/294,136

(22) Filed: Aug. 7, 2025

Related U.S. Application Data
(60) Provisional application No. 63/681,067, filed on Aug. 8, 2024.

(51) Int. Cl. G01S 5/02; H04L 25/02

(52) U.S. Cl. CPC G01S 5/02525; G01S 5/02523; H04L 25/0212

(57) ABSTRACT

Implementations relate to utilizing cellular signals to determine device location. In some implementations, a method includes obtaining location fingerprints, each fingerprint associated with a respective geographic location and being based on cellular signal characteristics at that location including multiple channel impulse responses (CIRs) for each location fingerprint for signals received from a plurality of cellular nodes. A fingerprint map is formed that references the location fingerprints. A request may be received for a particular geographic location of a particular user device, and a particular location fingerprint is obtained for the particular device that indicates cellular signal characteristics at the particular location, including CIRs for signals received from multiple cellular nodes. The particular fingerprint is compared to location fingerprints in the fingerprint map, a matching location fingerprint in the fingerprint map is selected, and an associated geographic location is output as the particular location of the particular device.

### CROSS-REFERENCE TO RELATED APPLICATIONS

This application is a non-provisional application that claims priority under 35 U.S.C. § 119 (c) to U.S. Provisional Patent Application No. 63/681,067, filed on Aug. 8, 2024 and entitled “Utilizing Cellular Signals for Determining Device Location,” which is hereby incorporated by reference herein in its entirety.

### BACKGROUND

Global Navigation Satellite Systems (GNSS), such as Global Positioning System (GPS), have long served as a fundamental technology for determining geographic locations of devices, navigation, and timing applications. However, GNSS signals exhibit limitations in specific environments, including weakened or absent signals within buildings, urban canyons, tunnels, parking structures, and other environments. To augment GNSS performance in challenging environments, some techniques involve dead-reckoning sensors such as inertial measurement units, lidars, or cameras. These sensors, however, accumulate errors over time and provide navigation solutions only within a local frame relative to the user's initial position. Another approach utilizes Signals of Opportunity (SOPs) for navigation, which are ambient signals not originally intended for positioning, navigation, and timing. Such signals include cellular, AM/FM radio, satellite communication, digital television, and Wi-Fi signals.

Cellular signals, particularly 3G, 4G, and 5G signals, are an attractive candidate for localization in GNSS-challenged environments due to their ubiquity, geometric diversity, high carrier frequency, high bandwidth, strong signal strength, and zero-deployment costs. Some techniques utilize cellular phone signals opportunistically in a user-centric approach for localization, which can provide positioning information. However, such techniques have several drawbacks, including requiring collaboration with cell towers near the local device by transmitting signals to such towers, which expends power of the local device and may have privacy concerns due to revealing the location of a user's device. In addition, cellular signals may have inherent accuracy limitations due to, for example, imprecise timing and synchronization, constraints of cellular receivers, multipath interference from signals reflecting off obstacles, signal availability limitations (e.g., for 5G signals), and coverage limitations from single providers.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, devices, and computer-readable media relating to utilizing cellular signals to determine device location. In some implementations, a computer-implemented method includes obtaining a plurality of location fingerprints, wherein each location fingerprint identifies and is associated with a respective geographic location and is based on cellular signal characteristics determined at the respective geographic location. The cellular signal characteristics include multiple channel impulse responses (CIRs) for each location fingerprint for signals received from a plurality of cellular nodes by one or more devices located at the respective geographic location. The method includes forming a fingerprint map that references the obtained location fingerprints. The method can include receiving a request for determination of a particular geographic location of a particular user device that is located at the particular geographic location, and obtaining a particular location fingerprint generated for the particular user device that indicates particular cellular signal characteristics determined at the particular geographic location. The particular cellular signal characteristics include particular CIRs for particular signals received from multiple cellular nodes by the particular user device located at the particular geographic location. The method includes comparing the particular location fingerprint to multiple respective location fingerprints in the fingerprint map, selecting a matching location fingerprint of the multiple respective location fingerprints in the fingerprint map based on the comparing, and causing a respective geographic location associated with the matching location fingerprint to be output as the particular geographic location of the particular user device. Any of the various features described below can be used in the method.

In some implementations, a computer-implemented method includes obtaining a plurality of location fingerprints, wherein each location fingerprint identifies and is associated with a respective geographic location and is based on cellular signal characteristics determined at the respective geographic location, the cellular signal characteristics including multiple channel impulse responses (CIRs) for each location fingerprint for signals received from a plurality of cellular nodes by one or more devices located at the respective geographic location; and forming a fingerprint map that references the obtained location fingerprints and geographic locations associated with the obtained location fingerprints. Forming the fingerprint map includes combining a subset of the obtained location fingerprints that are geographically proximate into one or more representative location fingerprints stored in association with one or more representative locations in the fingerprint map instead of the subset of location fingerprints, wherein the location fingerprints in the fingerprint map are comparable to a particular location fingerprint generated for a particular geographic location of a particular user device to determine the particular location.

Various features of the method are disclosed. For example, in some implementations, the multiple CIRs are time synchronized based on: being collected by a device simultaneously from the plurality of cellular nodes; or being collected by the device at different times from the plurality of cellular nodes and being adjusted for clock drift. In some implementations, each of the plurality of location fingerprints includes synchronized CIR data, wherein synchronization of the synchronized CIR data compensates for a respective clock bias of CIR data from the plurality of cellular nodes measured at different times when generating the plurality of location fingerprints. In some implementations, the method further includes receiving a request for determination of the particular geographic location of the particular user device; obtaining, by the at least one processor, a particular location fingerprint generated for the particular user device that indicates particular cellular signal characteristics determined at the particular geographic location, the particular cellular signal characteristics including particular CIRs for particular signals received from multiple cellular nodes by the particular user device located at the particular geographic location; comparing, by the at least one processor, the particular location fingerprint to multiple respective location fingerprints in the fingerprint map associated with a geographic area that includes the particular geographic location; selecting, by the at least one processor, a matching location fingerprint of the multiple respective location fingerprints in the fingerprint map based on the comparing; and causing, by the at least one processor, a geographic location associated with the matching location fingerprint to be output as the particular geographic location of the particular user device.

In some implementations, obtaining the plurality of location fingerprints includes obtaining identifications of the plurality of cellular nodes that have been determined to be time synchronized in output of cellular signals from the plurality of cellular nodes. In some implementations, forming the fingerprint map that references the generated location fingerprints includes: combining a subset of the location fingerprints that are geographically proximate into a representative location fingerprint stored in association with a representative location in the fingerprint map instead of the subset of the location fingerprints. In some implementations, combining the subset of the location fingerprints includes: forming a plurality of clusters of location fingerprints, wherein the location fingerprints within each cluster are associated with respective locations that are within a threshold distance and each cluster is associated with a cluster location, and obtaining the representative location fingerprint for each cluster of the plurality of clusters by aggregating the location fingerprints within the cluster; averaging the subset of the location fingerprints that are located within a threshold distance of each other to obtain the representative location fingerprint; or averaging the subset of the location fingerprints based on a Gaussian process.

In some implementations, the method further includes, prior to combining the subset of the location fingerprints, aligning, by the at least one processor, CIR data received from each of the plurality of cellular nodes, wherein the aligning compensates for a respective clock bias of the CIR data from the plurality of cellular nodes measured at different times. In some implementations, forming the fingerprint map includes excluding one or more of the plurality of location fingerprints at the respective geographic location that are associated with CIRs that do not meet one or more threshold signal characteristics. In some implementations, forming the fingerprint map includes: identifying a plurality of reference geographic areas that each include a subset of the geographic locations; determining an area representative fingerprint for each of the plurality of reference geographic areas based on a subset of the plurality of location fingerprints associated with the subset of the geographic locations; and storing each of the plurality of location fingerprints as a difference between the location fingerprint and the area representative fingerprint.

In some implementations, obtaining the plurality of location fingerprints includes obtaining identifications of the plurality of cellular nodes that have been determined to be time synchronized in output of cellular signals from the plurality of cellular nodes. In some implementations, determining the plurality of cellular nodes to be time synchronized includes, for each respective geographic location: causing a plurality of devices to each measure a plurality of cellular signals from two or more cellular nodes in a geographic area that includes the respective geographic location; determining a time synchronization of the plurality of cellular signals based on a time difference of arrival (TDOA) of the plurality of cellular signals received by the plurality of devices from the two or more cellular nodes; identifying a set of cellular nodes of the two or more cellular nodes that have a time synchronization under a synchronization threshold; and grouping and storing the set of cellular nodes as a synchronized cluster of cellular nodes associated with the geographic area, wherein the plurality of cellular nodes are obtained from the synchronized cluster.

In some implementations, the method further includes populating a geographical cellular system database with cellular signal data. In some implementations, the populating includes obtaining data characterizing cellular signals received in each of multiple geographic locations. In some implementations, the data can be obtained from devices at geographic locations, subject to user consent and privacy controls. In some implementations, the data can be collected from a device modem directly. In some implementations, the data can be analyzed to identify center frequencies of cellular channels. Cell identifications (IDs) of each cellular channel are identified based on the data, and the geographical cellular system database is updated with the data, including the center frequencies of the cellular channels, the cell IDs, bandwidth, and other cellular channel characteristics, for each of the multiple geographic locations. For example, the plurality of cellular nodes used in forming the location fingerprints and/or used to determine synchronized clusters of cellular nodes can be determined from the geographical cellular system database.

In some implementations, a system includes a processor and a memory coupled to the processor, with instructions stored thereon that, when executed by the processor, cause the processor to perform operations. The operations include receiving a request for determination of a particular geographic location of a particular user device; obtaining a particular location fingerprint generated for the particular user device that indicates particular cellular signal characteristics determined at the particular geographic location, the particular cellular signal characteristics including particular CIRs for particular signals received from multiple cellular nodes by the particular user device located at the particular geographic location; comparing the particular location fingerprint to multiple respective location fingerprints stored in a fingerprint map; selecting a matching location fingerprint of the multiple respective location fingerprints in the fingerprint map based on the comparing; and causing a respective geographic location associated with the matching location fingerprint to be output as the particular geographic location of the particular user device.

Various features of the system are disclosed. For example, in some implementations, the particular CIRs are time synchronized based on: being collected by a device simultaneously from the multiple cellular nodes; or being collected by the device at different times from the multiple cellular nodes and being adjusted for clock drift. In some implementations, the multiple respective location fingerprints are associated with a geographic area that includes the particular geographic location, and the operation of determining the multiple respective location fingerprints in the fingerprint map comprises: receiving an approximate geographic location of the particular user device and determining the geographic area based on a confidence level for an accuracy of the approximate geographic location.

In some implementations, the operation of comparing includes: obtaining a plurality of versions of the particular location fingerprint by applying a respective linear offset to the particular location fingerprint to generate each respective version; and comparing each of the plurality of versions of the particular location fingerprint to the multiple respective location fingerprints in the fingerprint map to obtain a plurality of correlation values, wherein each correlation value of the plurality of correlation values corresponds to a respective correlation of a version of the plurality of versions and a specific location fingerprint of the multiple respective location fingerprints. In some implementations, the operation of selecting the matching location fingerprint includes selecting a matched location fingerprint of the multiple respective location fingerprints that provides the highest correlation value.

In some implementations, each version of the plurality of versions is a matrix comprising a plurality of columns, each representing a CIR of a respective cellular node of the cellular nodes, and a plurality of rows, each representing corresponding samples of the CIRs represented by the columns, and wherein comparing each of the plurality of versions of the particular location fingerprint to the multiple respective location fingerprints in the fingerprint map includes calculating the respective correlation value for each respective correlation as a sum of correlations between each column of the plurality of columns of the version of the plurality of versions and a corresponding column in the specific location fingerprint of the multiple location fingerprints (rows and columns can be reversed in some implementations). In some implementations, the operation of comparing includes using a Fast Fourier Transform (FFT)-based correlation technique to determine correlations between the particular location fingerprint and the multiple respective location fingerprints, wherein the matching location fingerprint has a maximum correlation with the particular location fingerprint. In some of these implementations, the method includes applying zero-padding to the particular location fingerprint in the time direction (e.g., in a matrix representation).

In some implementations, the operation of selecting the matching location fingerprint includes determining an offset in samples of one of: the particular CIRs of the particular location fingerprint or the CIR of the matching location fingerprint that maximizes a correlation between the particular location fingerprint and the matching location fingerprint. In some implementations, the particular location fingerprint generated for the particular user device includes synchronized CIR data, wherein synchronization of the synchronized CIR data compensates for a respective clock bias of CIR data from the multiple cellular nodes measured at different times.

In some implementations, the operations further comprise: obtaining a plurality of location fingerprints, wherein each location fingerprint identifies and is associated with a respective geographic location and is based on cellular signal characteristics determined at the respective geographic location, the cellular signal characteristics including multiple channel impulse responses (CIRs) for each location fingerprint for signals received from a plurality of cellular nodes by one or more devices located at the respective geographic location; and forming the fingerprint map that stores the obtained location fingerprints and geographic locations associated with the obtained location fingerprints, wherein forming the fingerprint map includes combining a subset of the obtained location fingerprints that are geographically proximate into one or more representative location fingerprints stored in association with one or more representative locations in the fingerprint map instead of the subset of the location fingerprints.

In some implementations, the operations further comprise: obtaining a plurality of location fingerprints, wherein each location fingerprint identifies and is associated with a respective geographic location and is based on cellular signal characteristics determined at the respective geographic location, the cellular signal characteristics including multiple channel impulse responses (CIRs) for each location fingerprint for signals received from a plurality of cellular nodes by one or more devices located at the respective geographic location; and forming the fingerprint map that that stores the obtained location fingerprints and geographic locations associated with the obtained location fingerprints, wherein forming the fingerprint map includes, for each respective geographic location: extracting one or more features from the multiple CIRs associated with the geographic location, wherein the one or more features are selected from a group of: signal energy, signal peaks, differential time of arrival, overlap energy, differential energy ratio, delay spread, statistical moments of the multiple CIRs, and combinations thereof; forming a feature vector from the one or more features; and storing the feature vector in the fingerprint map as the location fingerprint in association with the geographic location.

Some implementations provide a system or device that includes a processor and a memory coupled to the processor. The memory may have instructions stored thereon that, when executed by the processor, cause the processor to perform operations that include one or more of the features described for any of the methods and/or systems above. Some implementations provide a non-transitory computer-readable medium with instructions stored thereon that, when executed by a processor, cause the processor to perform operations that may be similar to one or more features described for any of the methods and/or systems above. Some implementations provide a computer program product embodied on a non-transitory computer-readable medium that includes computer code that performs operations that may be similar to one or more features described for any of the methods and/or systems above.

### BRIEF DESCRIPTION OF THE DRAWINGS

FIG. 1 is a block diagram of an example network environment which may be used for one or more implementations described herein.

FIG. 2 is a diagrammatic illustration of an example cellular communication network, according to some implementations.

FIG. 3 is a flow diagram illustrating an example method to determine synchronized cellular nodes for use in determining the geographic location of a device, according to some implementations.

FIG. 4 is a flow diagram illustrating an example method to generate a fingerprint map that enables determination of device locations, according to some implementations.

FIG. 5 is a flow diagram illustrating an example method to generate a location fingerprint for a geographic location of a device, according to some implementations.

FIG. 6 is a flow diagram illustrating an example method to determine a geographic location of a device using cellular signals and a fingerprint map, according to some implementations.

FIG. 7 is a flow diagram illustrating an example method to provide a cellular system database that includes cellular signal data for geographic locations to use in determination of device locations, according to some implementations.

FIG. 8 is a diagrammatic illustration of two example plots that represent a location fingerprint, according to some implementations.

FIG. 9 is a block diagram of an example computing device which may be used to implement one or more features described herein.

### DETAILED DESCRIPTION

This disclosure relates to utilizing cellular signals to determine device location. Accurate device localization can be determined using various features. In some implementations, multiple location fingerprints are generated and referenced by a generated fingerprint map. Each location fingerprint identifies and is associated with a respective geographic location and indicates cellular signal characteristics determined at the geographic location. The cellular signal characteristics include multiple channel impulse responses (CIRs) in each location fingerprint for signals obtained from multiple cellular nodes (e.g., base stations) by one or more devices at the location.

A request can be received from a particular user device for determination of a particular (e.g., accurate) geographic location at which the device is located, e.g., for a navigation application, map application, etc. A particular location fingerprint is generated for the particular user device that indicates particular cellular signal characteristics determined at the geographic location of the device. The particular cellular signal characteristics include time-synchronized particular CIRs for signals obtained from multiple cellular nodes by the particular user device at the geographic location. The particular location fingerprint is compared to multiple respective location fingerprints in the fingerprint map that are associated with a geographic area that includes the geographic location. A matching location fingerprint of the location fingerprints in the fingerprint map is selected, and a geographic location associated with the matching location fingerprint is output as the particular geographic location of the particular user device.

For example, the comparing of fingerprints and selecting of the matched fingerprint from the fingerprint map can use a super-correlation technique. The particular location fingerprint is compared to the multiple map fingerprints to determine a matching map fingerprint. For example, offsets can be provided in samples of the CIR of the particular location fingerprint and these shifted CIRs are compared to the map fingerprint CIRs, where the matching map fingerprint is indicated by the shifted CIR that maximizes the correlation between the CIRs.

In some implementations, cellular signal data can be accurately provided by one or more databases of cellular signal data. For example, a geographical cellular system database can be populated with cellular signal data by obtaining data characterizing cellular signals received in each of multiple geographic locations, analyzing the data to identify center frequencies of cellular channels, identifying cell identifications (IDs) of each cellular channel based on the data, and updating the geographical cellular system database with the center frequencies of the cellular channels and the cell IDs for each of the multiple geographic locations. Synchronized cellular node clustering can be performed to indicate which cellular nodes in each geographical area are time synchronized in their cellular signals, e.g., have constant time offsets in their transmissions relative to each other over time. For example, a time synchronization of cellular signals can be based on a time difference of arrival (TDOA) of the cellular signals received by devices from cellular nodes, and a set of cellular nodes that have a time synchronization under a synchronization threshold are identified and can be clustered for use in one or more methods described herein.

Described techniques provide accurate determination of device location based on cellular signals. A user device's real-time location fingerprint can be compared with a pregenerated fingerprint map to estimate the user's location with high accuracy. The location fingerprints described herein are determined based on stable and synchronized cellular signals, enabling more consistent and accurate fingerprint determination and matching. Each location fingerprint can include CIR data from multiple cellular nodes transmitting signals at the same time, not just the strongest CIR that is received by a device, thus providing a more precise unique fingerprint for a particular location that can be matched in the fingerprint map. For example, techniques described herein can obtain and process cellular signals in a geographical area from all cellular providers simultaneously, enabling a more robust and accurate determination of location.

Using described techniques, location fingerprints can be generated to provide an accurate indication of signals at geographic locations, including time-synchronizing CIR data from multiple cellular nodes, reducing or eliminating the effects on the CIR data that is time dependent or clock dependent, and refining CIR data in each fingerprint that is based on multiple measurements over time. The matching of a device's current location fingerprint with location fingerprints in the fingerprint map includes compensating for clock drift and delay offsets in the CIR data to align fingerprints, allowing greater accuracy in match determination. Described techniques collect cellular signal data and determine device location based on cellular signals received by a device from cellular nodes without having to transmit cellular signals from the device to the nodes, thus reducing power expenditure on the user device and preserving the privacy of the geographic location of the user device. In some implementations, fingerprint maps described herein can include combined and/or compressed fingerprint data that advantageously reduce storage and network transmission requirements of fingerprint map data.

Described features advantageously enable accurate determination of the geographical location of a device using cellular signals. Technical advantages of described features include accurate location determination in geographic locations that may have reduced signal accuracy (e.g., due to line of sight or multipath interference), as well as reduction of processing resources and consumption of power resources on user devices by using more stable and accurate cellular signals in a more robust fashion and reducing the need for repeated location determinations.

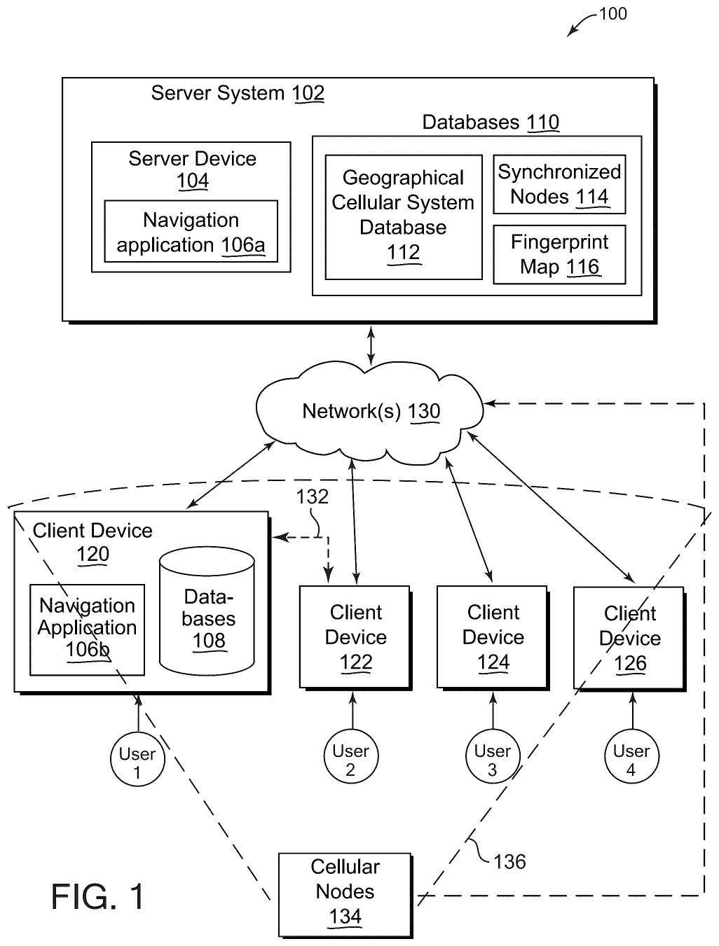

FIG. 1 illustrates a block diagram of an example network environment 100, in which some implementations described herein may be employed. Network environment 100 includes one or more server systems, e.g., server system 102 in the example of FIG. 1, and a plurality of client devices, e.g., client devices 120-126, each associated with a respective user of users U1-U4. Each of server system 102 and client devices 120-126 may be configured to communicate with each other via a network 130.

Server system 102 can include a server device 104 and a database 110. In some implementations, server device 104 may provide a navigation application 106a. In FIG. 1 and the remaining figures, a letter after a reference number, e.g., “106a,” represents a reference to the element having that particular reference number. A reference number in the text without a following letter, e.g., “106,” represents a general reference to embodiments of the element bearing that reference number.

Database 110 may be stored on a storage device that is part of server system 102. In some implementations, database 110 may be implemented using a relational database, a key-value structure, or other type of database structure. In some implementations, database 110 may include a plurality of partitions, each corresponding to a respective library for each of users 1-4, or each library may be implemented as a separate database. Server system 102 may be configured to implement the access permissions, such that data of a particular user is accessible only as permitted by the user. While FIG. 1 shows a single database 110, it may be understood that database 110 may be implemented as a distributed database, e.g., over a plurality of database servers.

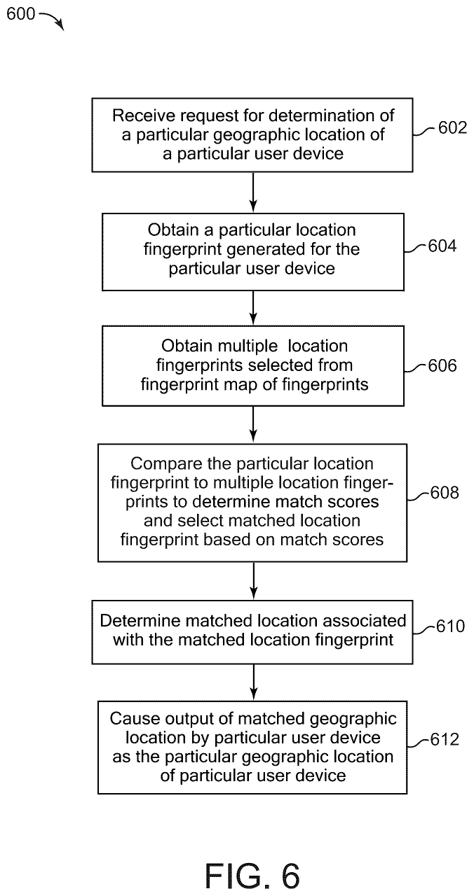

With respect to features described herein, database 110 can include a geographical cellular system database 112. Cellular system database 112 can store information about an operating cellular network system, such as a cellular phone network used by client devices 120-126. Stored information can include cell identifications (IDs) (e.g., each cell ID being an identification of a cell within the cellular network), cellular channels (e.g., assigned frequencies or frequency bands used for a particular cellular signal or cell ID) (a cell ID can sometimes transmit on multiple channels), bandwidth of cellular channels, transmission modes (describing how data is organized, modulated, transmitted), etc. In some implementations, the data in cellular system database 112 can be populated and/or updated, examples of which are described with reference to method 600 of FIG. 6.

Synchronized nodes database 114 can be used to store information that indicates which cellular nodes (e.g., transmitters) in particular geographic locations or areas are synchronized in the timing of their transmissions, e.g., have constant time offsets in their transmissions relative to each other over time. In some implementations, synchronized cellular nodes are clustered into groups stored in nodes database 114 that are used in determining location fingerprints as described herein. In some implementations, synchronized nodes database 114 can be a standalone database or can be incorporated in geographical cellular system database 112.

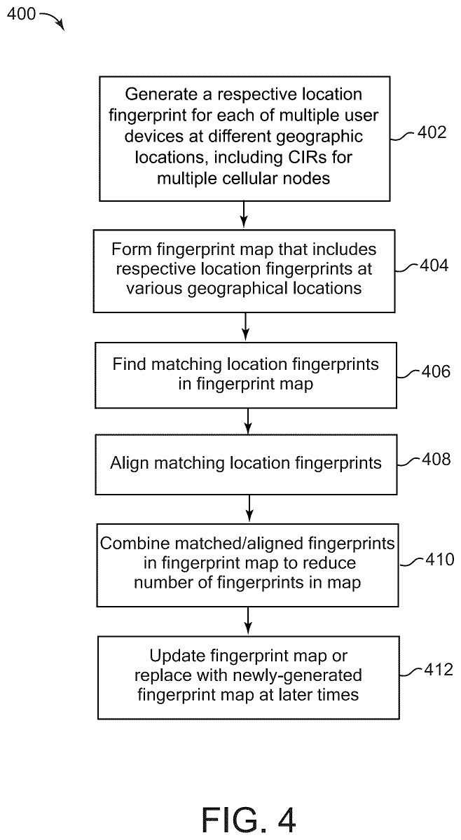

Fingerprint map 116 can be a database or other stored data structure that stores location fingerprints for geographical locations. Each geographic location identified in the map is associated with a unique fingerprint that indicates particular cellular signal characteristics determined at the associated geographic location. For example, each fingerprint can include CIR data that describes multiple CIRs detected at the geographic location, adjusted for reliability and accuracy. Examples of generation of a fingerprint map are described herein, e.g., with reference to FIG. 4. In some implementations, fingerprint map 116 can be a standalone database or can be incorporated in geographical cellular system database 112 or other database.

Network environment 100 can include one or more client devices, e.g., client devices 120, 122, 124, and 126, which may communicate with each other and/or with server system 102 via network 130. Network 130 can include one or more wireless cellular networks for use by cellular signals and devices, as used by various features described herein. Network 130 can also include any other types of communication network, including one or more of the Internet, local area networks (LAN) such as WiFi networks, wide area networks (WAN), wireless networks, switch or hub connections, etc. In some implementations, network 130 can include peer-to-peer communication between devices, e.g., using peer-to-peer wireless protocols (e.g., Bluetooth®, Wi-Fi Direct, etc.), etc. One example of peer-to-peer communication between two client devices 120 and 122 is shown by arrow 132.

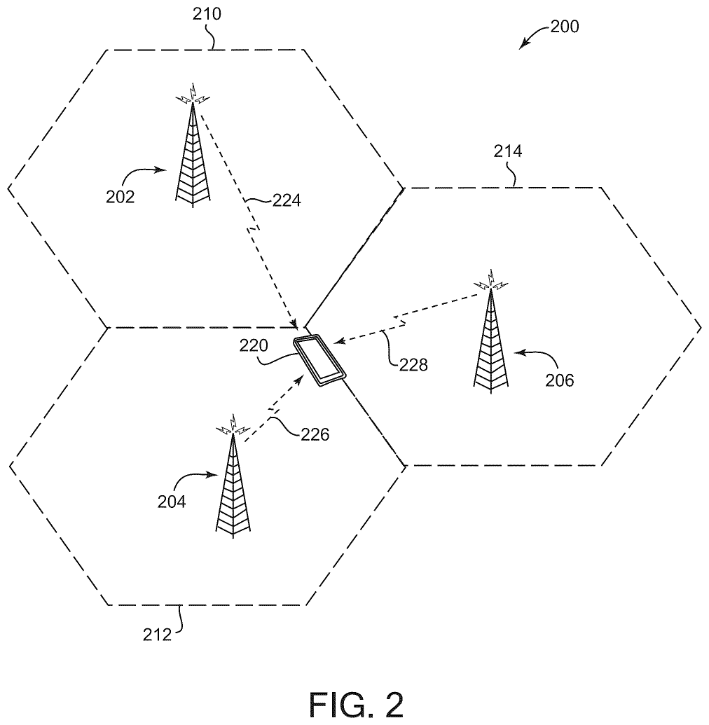

Cellular nodes 134 can transmit cellular signals over the air, e.g., as broadcast signals 136, and one or more client devices 120-126 may be capable of receiving the signals if within range of the broadcasting node (and any other required conditions apply). Cellular nodes 134 can include base stations (e.g., towers) that broadcast and receive cellular signals in particular geographic areas, and in some implementations the nodes 134 can include other receiver/transmitters of cellular signals. Geographic areas that can communicate cellular signals with one or more cellular nodes may be divided into cells (e.g., hexagonal cells) that each are assigned their own cell ID. In some implementations, each cellular node is associated with a particular cell, and each cell may be implemented by one or more cellular nodes. In some implementations, each cellular signal provider may independently divide a particular geographic area into cells, such that different cells are defined over the geographical area by different cellular providers; however, techniques described herein can obtain and process cellular signals in the geographical area from all present cellular providers simultaneously, regardless of their different cell designations. For example, the cellular nodes can transmit cellular signals in any of various formats including 3G, 4G, 5G, etc. In some examples, 5G cells can include femtocells (0.1 kilometer radius), pico cells (0.2 km radius), micro cells (2.0 km radius), and macro cells (30 km radius) that cover different ranges based on using different types of node transmitters. An example of cellular nodes 134 is described with respect to FIG. 2.

In some implementations, some or all of cellular nodes 134 can be connected to networks 130 and can communicate with other devices such as server system 102 and/or client devices 120-126 via at least one cellular communication network in networks 130.

In various implementations, users 1, 2, 3, and 4 may communicate with server system 102 and/or each other using respective client devices 120, 122, 124, and 126. In some examples, users 1, 2, 3, and 4 may interact with each other via applications running on respective client devices and/or server system 102 and/or via a network service, e.g., a social network service or other type of network service, implemented on server system 102. For example, respective client devices 120, 122, 124, and 126 may communicate data to and from one or more server systems, e.g., server system 102, and cellular nodes 130, via networks 130.

In some implementations, the server system 102 may provide appropriate data to the client devices such that each client device can receive communicated content or shared content uploaded to the server system 102 and/or a network service. In some examples, users 1-4 can interact via audio or video calls or conferencing, audio or image data sharing, audio, video, or text chat, or other communication modes or applications. In some implementations, client devices can communicate directly with each other, e.g., using peer-to-peer communications between client devices. In some implementations, a “user” can include one or more programs or virtual entities, as well as persons that interface with the system or network.

In some implementations, any of client devices 120, 122, 124, and/or 126 can provide one or more applications. For example, as shown in FIG. 1, client device 120 may provide navigation application 106b. Client devices 122-126 may also provide similar applications. Navigation application 106a may be implemented using hardware and/or software of client device 120. In different implementations, navigation application 106a may be a standalone client application, e.g., executed on any of client devices 120-126, or may work in conjunction with navigation application 106b provided on server system 102.

Navigation application 106 may provide various features, implemented with user permission, that are related to navigation, e.g., determining a geographic location of the client device on which the application 106 is executing and outputting an indication of that location. For example, navigation features provided by navigation application 106 can include one or more of determining current geographic location of the client device, receiving and processing location or navigation data, communicating with cellular nodes of a cellular network (using hardware and software of the client device) to communicate with other devices, displaying navigation information including maps, location information (e.g., images, text, audio, etc. related to current location or larger area), outputting alerts based on current location, storing navigation data (with user permission and as specified in user settings) in local database 108b, providing user interfaces to navigate or view location data, etc. In some implementations, navigation application 106 includes additional features besides navigation functions. For example, a communications application (e.g., chat application, video conference application, etc.) can be considered a navigation application that includes navigation processing as well as processing of other types of data, e.g., image, video, audio, text, etc.

Navigation application 106 can perform or interface with techniques described herein. For example, navigation application 106 can receive cellular signals and/or measurements based on cellular signals as processed by components on the client device, can populate or update the geographical cellular system database 112 in local storage and/or on another device such as server system 102, can detect and cluster synchronized cell nodes and store the clusters in local databases 108b or send the cluster information to another device such as server system 102, can generate a location fingerprint for a current geographic location and provide the location fingerprint to other devices (e.g., server system 102), can compare a current location fingerprint to location fingerprints in a fingerprint map (stored in databases 108b or server system 102) and determine a current geographical location of the client device therefrom, and can display the current location on a display device, e.g., in map format, text format, etc.

While the foregoing description refers to a variety of features of navigation application 106, it will be understood that in various implementations, navigation application 106 may provide fewer or more features. Further, each user is provided with options to enable and/or disable certain features.

Client device 120 may include databases 108 of user 1, which may be a standalone database or in some implementations, may be usable in combination with databases 110 on server system 102. For example, with user permission, database 108 and databases 110 may be synchronized via network 130. In some implementations, database 108 may include navigation and location data (e.g.), current and past locations and/or location fingerprints of client device 120, cellular system database data, synchronized nodes data, fingerprint map data (e.g., part or all of data in database 112, database 114, and/or database 116, in addition to or instead of the server system 102 storing that data), etc. In some implementations, databases 108 on client device 120 may include a subset of data that is stored by databases 110 on server system 102. For example, such implementations may be advantageous when a limited amount of storage space is available on client device 120. In some implementations, for example, client devices 120-126 can each store one or more of the databases 110 (e.g., databases 112, 114 and/or 116) or portions thereof.

In different implementations, client device 120 and/or server system 102 may include other applications (not shown) that may be applications that provide various types of functionality, e.g., image and audio capture and/or editing, calendar, address book, e-mail, web browser, shopping, transportation (e.g., taxi, train, airline reservations, etc.), entertainment (e.g., a music player, a video player, a gaming application, etc.), social networking (e.g., messaging or chat, audio/video calling, sharing images/video, etc.) and so on. In some implementations, one or more of the other applications may be standalone applications that execute on client device 120. In some implementations, one or more of the other applications may access a server system, e.g., server system 102, that provides data and/or functionality of the other applications.

A user interface on a client device 120, 122, 124, and/or 126 can enable the display of user content and other content, including navigation and location content, images, video, audio content, text, and other content as well as communications, privacy settings, notifications, and other data. Such a user interface can be displayed using software on the client device, software on the server device, and/or a combination of client software and server software executing on server device 104, e.g., application software or client software in communication with server system 102. The user interface can be displayed by a display device of a client device or server device, e.g., a touchscreen or other display screen, projector, etc. In some implementations, application programs running on a server system can communicate with a client device to receive user input at the client device and to output data such as visual data, audio data, etc. at the client device.

For case of illustration, FIG. 1 shows one block for server system 102, server device 104, database 110, and shows blocks for client devices 120, 122, 124, and 126. Server blocks 102, 104, and 110 may represent multiple systems, server devices, and network databases, and the blocks can be provided in different configurations than shown. For example, server system 102 can represent multiple server systems that can communicate with other server systems via the network 130. In some implementations, server system 102 can include cloud hosting servers, for example. In some examples, database 110 may be stored on storage devices provided in server system block(s) that are separate from server device 104 and can communicate with server device 104 and other server systems via network 130.

Also, there may be any number of client devices. Each client device can be any type of electronic device, e.g., mobile device, cell phone, smartphone, tablet computer, desktop computer, laptop computer, portable or television, TV set top box or entertainment device, wearable devices (e.g., display glasses or goggles, earbuds or headphones, wristwatch, headset, armband, jewelry, etc.), personal digital assistant (PDA), media player, game device, etc. In some implementations, network environment 100 may not have all of the components shown and/or may have other elements including other types of elements instead of, or in addition to, those described herein.

Other implementations of features described herein can use any type of system and/or service. For example, any of various networked services (e.g., connected to the Internet) can be used. Any type of electronic device can make use of features described herein. Some implementations can provide one or more features described herein on one or more client or server devices disconnected from or intermittently connected to computer networks. In some examples, a client device including or connected to a display device can process data stored on storage devices local to the client device, e.g., received previously over communication networks.

FIG. 2 is a diagrammatic illustration of an example cellular network 200 that can transmit cellular signals to user devices. In this simplified example, cellular nodes 202, 204, and 206 can be base stations that broadcast wireless cellular signals and receive wireless cellular signals from devices. Cells 210, 212, and 214 are areas defined around each cellular node 202, 204, and 206, respectively, where each cell has been assigned a different cell ID that identifies the respective cell. The cell ID is broadcast by the associated node.

In this example, a user device 220 (e.g., a smartphone) being carried by a user is at a location such that it can receive cellular signals from all three nodes 202, 204, and 206. For example, user device 220 receives cellular signal 224 from node 202, receives cellular signal 226 from node 204, and receives cellular signal 228 from node 206. The user device can measure characteristics of all of these signals and provide signal data for use in accurately determining the location of the user device, as described herein.

### Determining Synchronized Cellular Nodes in Database

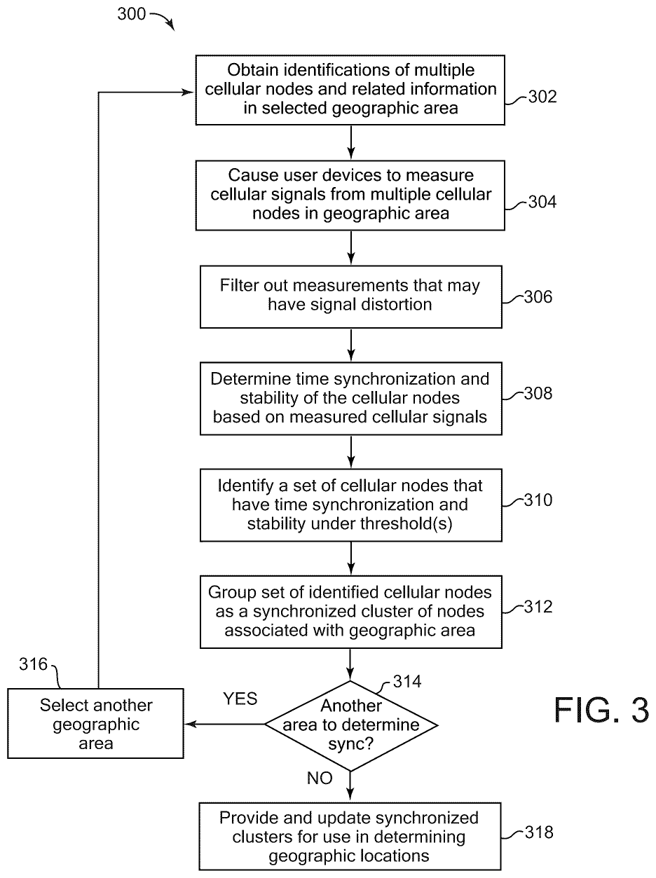

FIG. 3 is a block diagram illustrating a method 300 to determine synchronized cellular nodes for use in determining the geographic location of a device, according to some implementations. In some implementations, some or all of method 300 can be implemented, for example, by one or more client devices 120, 122, 124, or 126 as shown in FIG. 1. In some implementations, some or all of method 300 can be implemented on one or more server systems 102 as shown in FIG. 1, and/or on both server device(s) and client device(s). In described examples, the implementing system includes one or more digital processors or processing circuitry (“processors”), and one or more storage devices (e.g., a database or other storage). In some implementations, different components of one or more servers and/or clients can perform different blocks or other parts of the method 300. Some implementations can have one or more blocks of method 300 performed by one or more other devices (e.g., other client devices or server devices) that can send results or data to a first device that performs other blocks.

Blocks of method 300 are only performed if permission is obtained by user(s) who owns or are associated with the client device(s) being used.

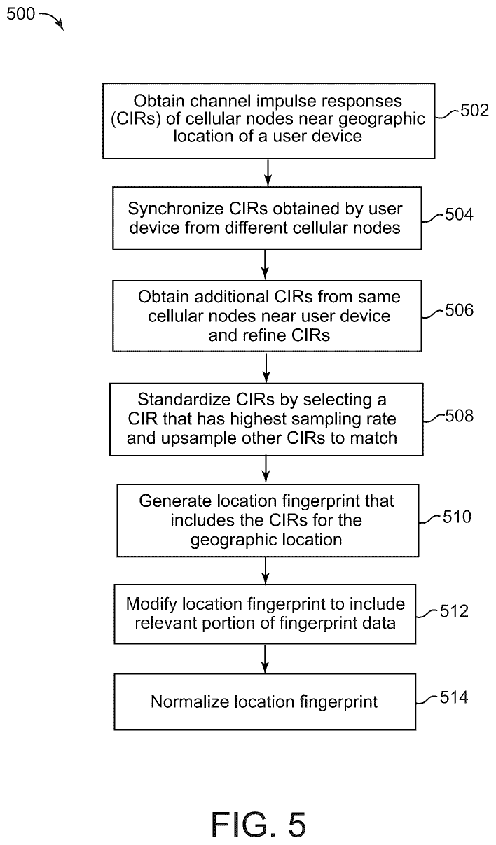

Method 300 can be used to determine which cellular nodes in particular areas provide synchronized and stable signals that can be used to accurately determine the locations of user devices in methods described herein. For example, such cellular signals are accurate enough to be used to determine location fingerprints as used in implementations described with reference to FIGS. 4 and 5.

Method 300 may begin at block 302. In block 302, identifications of multiple cellular nodes and related cellular information are obtained in a selected geographic area. For example, the identifications and related information can be obtained from a geographic cellular system database, such as database 112 as described above with reference to FIG. 1 and examples of which are described below with reference to FIG. 6. For example, such a database can be implemented on a server system 102 that implements method 300, on a different server system 102, on a client device 120-126 implementing method 300, or on a different client device 120-126. Some examples of creating or populating a geographic cellular system database suitable for providing the information are described below with reference to FIG. 6, and/or existing other database(s) can be accessed that can provide the information. The identifications can include cell IDs provided by the nodes in the geographical area and the center frequencies of the cellular channels for those cell IDs, as well as signal type (e.g., 3G, 4G, 5G, etc.), bandwidth of the channels, duplex mode (frequency division duplex (FDD) or time division duplex (TDD)), cellular provider, etc. Block 302 may be followed by block 304.

In block 304, after securing user permission, user devices in the selected geographic area are caused to measure multiple cellular signals (cellular channels) provided from the identified multiple cellular nodes in the selected geographic area. For example, one or more user devices can be instructed (e.g., by a server system 102 or by applications on the user devices) to each measure cellular signals from multiple cellular nodes in geographic areas in which those user devices are located. The measurements performed by a user device can be synchronous for that user device, e.g., are initiated simultaneously; measurements of different user devices need not be synchronized with each other. In some implementations, the user devices instructed to perform the measurements are stationary or moving sufficiently slowly (e.g., below a threshold velocity) in the geographic area, to allow more accurate measurements than for faster moving user devices. In some implementations, e.g., if not all measurements are performed synchronously on a user device, a user device can measure CIRs from multiple cellular nodes and can synchronize the CIRs, similar to blocks 502 and 504 of method 500 of FIG. 5 described below. For example, a modem of a user device may be capable of processing only a few cellular node signals at a time (e.g., four). In some examples, the user device may measure signals from (reference) cellular node A and nodes B, C, and D for 100 ms, then measure signals from node A (still tracking) and nodes E, F, and G for another 100 ms, and then measure signals from node A and nodes H, I, and J for another 100 ms, so as to measure signals from different cellular nodes. Since the signals are measured in rapid succession and a single reference node is used, the signals are valid. Block 304 may be followed by block 306.

In block 306, optionally, measured signals that have or may have signal distortion can be filtered out from the collected measured signals of block 304. This causes the remaining measured signals after filtering to be more reliable for assessing the synchronization of the cellular nodes. For example, in some implementations, cellular signals that are measured when there is not a clear line-of-sight (LOS) between user device and cellular node can be filtered out. In some implementations, cellular signals that have strong multipath interference can be filtered out. In some implementations, signals that do not have significant distortion (e.g., do not have strong multipath interference) can be determined by examining the shape of the CIR of the signal, e.g., confirming that it has a single maximum or peak that is a threshold amount larger than other values in the CIR. In some implementations, distortion in signals can be determined using a frequency discriminator and/or other components in a receiver of user devices to detect amplitude, frequency, and/or phase shift in the cellular signals to determine whether the signals are delayed or different compared to other measured signals and/or compared to expected center frequencies and other characteristics of these signals. If distortion in a measured signal is detected, the measured signal is removed from the set of collected measured signals. Thus, in some implementations, only the measured signals with the least potential for signal distortion can remain in the set of collected measured signals. In some implementations, all or most of the measured signals can be retained in the set and not filtered out, e.g., all the measured signals can be used in the fingerprint matching process of FIG. 6, if the fingerprint matching process is robust to the corresponding signal distortions. Block 306 may be followed by block 308.

In block 308, the time synchronization and stability of the cellular nodes are determined based on the filtered set of measured cellular signals. For example, the time difference of arrival (TDOA) of the filtered measurement signals is determined. A TDOA represents the time difference between the times that signals from different cellular nodes take to arrive at the user device. The time synchronization can be determined based on the TDOA, e.g., based on a comparison of TDOAs from various collections of measured signals (e.g., from same or different devices) in the same geographic neighborhood.

In some implementations, the stability of the cellular signals from the cellular nodes is also determined. In some implementations, the stability determination can be based on a measured frequency stability of the signals (e.g., Allan deviation) and/or a carrier-to-noise ratio (CNR) of the signals determined for the signals by the user device when collecting the cellular signal measurements, which can indicate the stability of the channel impulse response (CIR) from the nodes providing the cellular signals, and/or the stability of the clocks of these nodes. Other techniques for determining synchronization and/or stability can be used in other implementations. Block 308 may be followed by block 310.

In block 310, a set of cellular nodes of the measured cellular nodes is identified that have time synchronization with each other that is under a threshold. For example, if the stability of the TDOA over time of two cellular signals is below the threshold (e.g., if the TDOA does not vary over time by more than the threshold amount), those signals are identified as being sufficiently synchronized to be used in the user device localization (location detection) described herein, and nodes having synchronization outside of that threshold are removed from the identified set of nodes. Other techniques can alternatively be used to determine the synchronization between the cellular signals. In some examples, a synchronization offset stability threshold of 10 nanoseconds can be used, or other thresholds can be used in other implementations. Block 310 may be followed by block 312.

In block 312, the set of identified cellular nodes are grouped as a synchronized cluster of nodes that are associated with the geographic areas. These nodes can be referenced based on the geographic location. Block 312 may be followed by block 314.

In block 314, it is checked whether there is another geographic area to determine synchronized nodes. For example, a different geographic area than geographic areas already processed can be examined for synchronization and clusters determined, e.g., if it has been greater than a threshold amount of time since that geographic area was last processed for synchronization. If there is another area to determine synchronization, the method continues to block 316 to select another geographic area, and the method then returns to block 302 to determine a synchronized cluster of nodes for the newly-selected geographic area.

If there are no other geographic areas to determine synchronization, the method continues to block 318, in which the synchronized clusters are provided for use in determining geographic locations, e.g., as described in methods herein. In some implementations, the synchronized clusters can be stored in a synchronized nodes database (e.g., synchronized nodes database 114 of FIG. 1) and/or in a geographical cellular system database as described herein, e.g., database 112 of FIG. 1.

It should be noted that synchronized clusters of nodes can be determined partially or completely simultaneously at multiple different geographical areas, such that method 300 (or portions thereof) can be performed multiple times at least partially simultaneously for different geographic areas, and/or a sequential determination for one or more different areas can be performed.

The synchronization assessment of method 300 can be performed at an initial time for each specific geographic area to establish an initial baseline for that area. In some implementations, the synchronized clusters can also be updated over time, e.g., periodically. For example, method 300 can be performed to update the cellular system database with new data collected by the same or different user devices in the geographic areas, to enable the database to reflect changes in cellular node synchronization levels over time.

### Generating a Location Fingerprint Map Using Multiple User Devices at Various Geographical Locations

FIG. 4 is a block diagram illustrating a method 400 to generate a fingerprint map that enables determination of device locations, according to some implementations. In some implementations, some or all of method 400 can be implemented, for example, by one or more client devices 120, 122, 124, or 126 as shown in FIG. 1. In some implementations, some or all of method 400 can be implemented on one or more server systems 102 as shown in FIG. 1, and/or on both server device(s) and client device(s) (e.g., some blocks, or portions of blocks, on server devices and some blocks (or portions of blocks) on client devices). In described examples, the implementing system includes one or more digital processors or processing circuitry (“processors”), and one or more storage devices (e.g., a database or other storage). In some implementations, different components of one or more servers and/or clients can perform different blocks or other parts of the method 400. Some implementations can have one or more blocks of method 400 performed by one or more other devices (e.g., other client devices or server devices) that can send results or data to a first device that performs other blocks.

Blocks of method 400 are only performed if permission is obtained by user(s) who owns or are associated with the client device(s) being used.

Method 400 can be used to determine a fingerprint map that includes location fingerprints associated with geographic locations and that can be used to accurately determine the locations of user devices in methods described herein. For example, the location fingerprints and fingerprint map can be used to determine location of a user device as described with reference to FIG. 6.

Method 400 may begin at block 402. In block 402, multiple location fingerprints are obtained, where a respective location fingerprint is generated and obtained for each user device of multiple user devices at different geographic locations. Each location fingerprint includes time-synchronized CIRs for multiple cellular nodes. The location fingerprint provides a unique signature for the location of each user device. Some example techniques for generating a location fingerprint are described with reference to method 500 of FIG. 5. The data used to generate the location fingerprints can be collected by the respective user devices at different times, and the respective location fingerprints can be generated at different times.

In some implementations, a respective location fingerprint can be generated on the user device that measures the cellular signals and the location fingerprint then is obtained by a server system via a communication link (e.g., network connection) to the user device. In some implementations, the location fingerprint can be generated by a server system that receives cellular signal data (e.g., time-synchronized CIR data and other data) from the user device that measures the cellular signals. In some implementations, the location fingerprint can be generated partially by the user device, and partially by the server system. For example, in some implementations, one or more server systems (e.g., server system 102 of FIG. 1) can send a respective request to each user device (e.g., client devices 120-126 of FIG. 1) to collect a respective set of cellular signals by that device, and the user devices can send collected cellular signal data to the server, where the server generates the location fingerprint from the data. The server requests can be sent at the same or different times to different user devices. In some implementations, one or more (or all) user devices can collect the respective sets of cellular signal data (and/or generate the fingerprints) without a request from a server system. In various implementations, the user devices can send collected sets of cellular signal data to a server system for processing according to method 400, and/or the user devices can process the collected cellular signal data to generate the location fingerprints and send the location fingerprints to the server system. In some implementations, the user devices can perform all the blocks of method 400, e.g., generate a fingerprint map locally on the user device. Block 402 can be followed by block 404.

In block 404, a fingerprint map is formed or generated, which includes respective location fingerprints at various geographical locations. For example, the location fingerprints generated or obtained for the user devices in block 402 can be included in the fingerprint map. Each location fingerprint can be associated with its geographical location in the map. In various implementations, the fingerprint map references obtained generated location fingerprints, and location fingerprints provided in the map can be full individual location fingerprints and/or can be derivations thereof, e.g., compressed fingerprints, aggregations of multiple fingerprints, etc. as described herein.

The location fingerprints can be represented in the fingerprint map in any of multiple ways. For example, in some implementations an entire fingerprint matrix described in block 510 of FIG. 5 can be stored at each point of the fingerprint map. In some implementations, each point of the map can represent a location in a grid of locations (e.g., referenced by latitude and longitude). This approach provides a large amount of detail in the fingerprint map, but also may be the most demanding in terms of computational and/or network resources compared to other options described below.

In some implementations, a selected-points format can be used for the fingerprint in the map. This refines the above format (that stores each entire fingerprint matrix) by isolating and storing only the most significant samples of the fingerprints in the fingerprint map. For example, to determine the most significant samples, each sample of a given node's CIR can be evaluated and categorized into either signal or noise. Techniques such as thresholding and matched filtering can be used to distinguish between signal-induced peaks and noise. Those samples that are categorized as signals (e.g., characterized by their peaks and specific delays) are retained and samples that do not meet threshold(s) of one or more signal characteristics (e.g., threshold power or amplitude) are categorized as noise and can be excluded from the fingerprint map. These selected samples can be cataloged as part of the comprehensive fingerprint in a particular format (e.g., [[node1, sample1, power1], [node1, sample2, power2], . . . ]), providing a compact and informative representation of the fingerprint data. Thus, a technical benefit of this format includes reduced data storage needs since insignificant CIR observations are not stored or used during lookup of fingerprints.

In some implementations, a relative fingerprint format can be used. In such a format, multiple reference geographic areas are identified that each include a subset of geographic locations. This format establishes an area representative fingerprint (baseline fingerprint) for each geographical area (where a geographical area includes multiple geographic locations for which fingerprints are associated). The baseline fingerprint can serve as an average reference point and can be based on a subset of the location fingerprints that are associated with the subset of the geographic locations. Each individual location fingerprint is represented and stored as a difference from this area representative fingerprint to the individual fingerprint associated with a particular location. This format stores each location fingerprint as a series of deviations or changes from the average reference point, providing a dynamic view of how each location's fingerprint differs from the norm within that area. This saves storage and computation resources via use of a more efficient fingerprint map.

In some implementations, location fingerprints stored in the fingerprint map can be represented in a feature-based format that stores feature vectors. In this format, instead of storing the entire fingerprint matrix or a compressed version thereof in the map, the raw 2D fingerprint matrix (e.g., of block 510 of FIG. 5) can be processed through a feature extraction layer. This layer can be configured to transform a group of synchronized CIRs sharing a common receiver time bias, such as a high-dimensional fingerprint matrix which includes multiple synchronized CIRs as described herein, into a lower-dimensional, highly descriptive feature vector that includes multiple features extracted from the CIRs. This feature vector is stored as the canonical representation of a location fingerprint in the fingerprint map.

Use of a feature-based format may provide several technical advantages. This format can significantly reduce the data storage and transmission requirements compared to storing the full matrix or some compressed or combined formats. Furthermore, by focusing on the most salient and stable aspects of the measured signals, the resulting feature vector can be more robust to transient noise and minor environmental changes, leading to improved accuracy and efficiency in the matching operations described in block 406.

The feature extraction layer can be configured to extract a wide range of features from the CIRs or matrix. The resulting feature vector for a given location may comprise any combination of the following example features.

One type of extracted feature can be active region characteristics. For example, for each individual CIR (e.g., column) in the fingerprint matrix, the layer can first identify an active region corresponding to a range of samples containing the significant signal subspace and excluding the preceding and succeeding noise floor (the baseline level of background electronic noise in the receiving system). In some implementations, the range of samples of the active region can be selected by using an energy threshold. For example, the CIR can be scanned and a point where the signal energy first rises a threshold amount above background noise and a point where the energy first falls down below the threshold amount is determined, where the active region is between these two points. The significant signal subspace can be the portion of the CIR signal that contains the actual multipath components (reflections), where the unique characteristics of the geographic location are encoded, as opposed to the noise subspace having random noise.

Based on this active region, features can be extracted, including signal energy, which is the total energy within the active region of each CIR, e.g., calculated as the sum of the squared magnitudes of the samples within that region. This provides a robust measure of the received power from each signal source. Another active region feature can be signal peaks, which is the magnitude (power) and relative delay of significant signal peaks within each CIR. The delays can be measured relative to the common time reference of the fingerprint, providing geometrically meaningful information. For example, a feature vector can include the N strongest peaks or all peaks exceeding a predetermined threshold.

Another type of extracted feature can be inter-CIR relational features. Leveraging the synchronized nature of the CIRs within the matrix, these features describe the relationships between pairs of CIRs. The relational features can include Differential Time of Arrival (DTOA), which is the difference in arrival time between the first significant peak of one CIR and the first significant peak of another CIR. Due to the common clock bias of the CIRs, this feature is a strong indicator of the user's geometric position relative to the signal sources. In some implementations, a DTOA calculation can be extended to include combinations of other significant peaks of the CIRs, rather than being limited to only the most powerful peak from each CIR. The relational features can include overlap energy (e.g., cross-correlation), which is a measure of the temporal similarity between pairs of CIRs. This can be computed by, for example, calculating the integral of the product of the magnitudes of the two CIRs or by finding the peak of their cross-correlation function. A high overlap value indicates that the multipath components from different sources have arrived with similar delay profiles, and is a highly location-specific attribute. The relational features can include differential energy ratio, which is the ratio of the total energy of one CIR to another, providing a normalized view of the relative signal strengths.

Another type of extracted feature can be statistical and structural features. These features can include delay spread, which is the Root Mean Square (RMS) delay spread for each CIR, which quantifies the temporal dispersion of the channel and characterizes the richness of the multipath environment. The statistical features can include statistical characteristics of the CIRs, which include variance, skewness, and kurtosis of the magnitude of each CIR, and describe the statistical distribution of the multipath components. The statistical features can include matrix properties, which are features derived from the 2D fingerprint matrix as a whole, such as its singular values (e.g., produced from applying Singular Value Decomposition (SVD) to the entire 2D fingerprint matrix, and representing the principal components or energy distribution across the matrix) and/or rank (e.g., indicating complexity and diversity of the CIR signals received, where a higher rank suggests that the signals from different sources are more distinct and less redundant, and a low rank suggests the signals are very similar or correlated), which characterize the overall dimensionality and diversity of the combined received signals.

A feature vector is formed from the multiple extracted features.

In some implementations, the feature extraction layer can include a trainable machine learning model, such as a neural network. For example, instead of relying on predefined rules, such a model can learn, via training, to automatically transform the high-dimensional fingerprint matrix into a lower-dimensional and descriptive feature vector (which can be referred to as an embedding). The model is trained to identify and encode the most robust signal characteristics that are indicative of a specific location. For example, a trainable encoder can be configured to generate this feature vector. The encoder can be trained using a methodology where it processes multiple fingerprints and adjusts its internal parameters to produce a desirable output. The training objective may be to configure the encoder to generate feature vectors that are mathematically proximate for fingerprints originating from the same location, and mathematically distant for fingerprints from different locations. The resulting trained encoder, having learned to map a raw fingerprint to a feature vector, can then be used as the feature extraction layer for fingerprints processed by the system.

A determined feature vector can be stored in the fingerprint map as a fingerprint, e.g., in place of a fingerprint matrix as described above, and compactly represents the multi-signal environment at a specific location based on the CIRs of the fingerprint matrix. A respective feature vector can be formed for each geographic location. In some implementations, multiple feature vectors can be stored in the fingerprint map in a relative fingerprint format as described above.

The utility of the feature-based format can extend to the generation of the fingerprint map itself. In some implementations, the extracted feature vectors can be used as training data for a machine learning model. For instance, a Gaussian process model can be trained on the feature vectors and their corresponding geographic locations within a particular area. This allows the system to generate a continuous feature map over that geographic area, and enables the model to predict an expected feature vector of a particular location within that geographic area at which no measurement was taken. In some implementations, predicted feature vectors can be determined and stored in the map at locations where no measurement was taken, as preprocessing, thus making the fingerprint map more complete with predicted data and avoiding having to take additional signal measurements. In some implementations, predicted feature vectors can be determined on demand when determining a location of a device in a localization process similar to that of FIG. 6 (e.g., instead of pre-calculating and storing the interpolated feature vectors in the map, the model can generate a prediction for any given location on-demand, which saves storage space at the cost of higher computation cost during the lookup). In another example, a neural network (NN), such as a Multi-Layer Perceptron (MLP), can be trained to learn a direct mapping function between an input feature vector and a user's geographic coordinates (Location=f (Feature_Vector)). For example, the training data can include many pairs, where each pair is an extracted feature vector and a known geographic coordinate. The neural network learns the relationship between the feature vectors and the physical locations from this dataset. This creates a highly efficient localization model that can be deployed on a user device or server. For example, the NN model can be used to determine a location of a device in a localization process similar to that of FIG. 6. The training of the NN model can replace the generation of the fingerprint map and the use of the trained NN model can replace the use of a fingerprint map and localization process when determining device location.

Block 404 can be followed by block 406.

In block 406, in some implementations, matching location fingerprints are found in the fingerprint map to enable matched fingerprints to be combined. For example, a matching operation can be used to determine which fingerprints in the map are sufficiently similar to each other to be combined (e.g., averaged or grouped into a single cluster as described below). For example, location fingerprints within a threshold distance of each other can be compared for matching. In some implementations, e.g., when using an averaging technique as described below, a radius is defined around a location and the fingerprints within that radius are compared for matching. For example, the radius can depend on fingerprint density at the location, e.g., the radius can extend around an area that has a threshold or higher density of fingerprints around the location. The matching operation includes compensation for varying clock biases inherent to each collected fingerprint. For example, in some implementations, the matching is performed similarly to the matching of fingerprints described below with reference to blocks 604-608 of FIG. 6 (e.g., using a super-correlation technique). The matching operations can result in one or more sets of location fingerprints determined to match and thus may be combined in the fingerprint map. Block 406 can be followed by block 408.

In block 408, location fingerprints that are matched in block 406 are aligned with each other. For example, fingerprints of one or more of the sets of fingerprints to be combined can be modified to align the fingerprints in each set so that they may be accurately combined. For example, in some implementations, a set of fingerprints to be combined can be aligned by adjusting the timing of each fingerprint in the set to have the same timing, and/or by aligning the fingerprints in the set with one particular fingerprint in the set (e.g., the particular fingerprint can be a fingerprint having the most confidence in the set, such as the most recently collected by a user device, or based on the strongest signal, etc.), or by other normalization of the set of fingerprints to be combined. Block 408 can be followed by block 410.

In block 410, matched and aligned fingerprints are combined in the fingerprint map to reduce the number of fingerprints in the map. In some implementations, each set of matched location fingerprints can be combined into a representative location fingerprint that occupies a single location in the fingerprint map and represents the set of matched location fingerprints. For example, fingerprints from various user devices may be collected across diverse times, and the various geographical locations of the fingerprints are inherently dependent on the positions of the user devices at the time of fingerprint data collection, leading to a non-uniform distribution of location density across the fingerprint map. To counteract this disparity and ensure the generation of more statistically robust fingerprints, geographically proximate fingerprints can be combined. For example, a more even or uniform distribution of fingerprints in the map can enable more accurate interpolation between two fingerprints to determine a fingerprint located between the two fingerprints. Furthermore, there may be many fingerprints located in the same location and/or very close to each other geographically, and the number of these fingerprints in the map can be reduced in the fingerprint map to save computational resources such as storage space and transmission bandwidth (e.g., when a server system sends a fingerprint map to a user device over a network, e.g., for localization as described in method 600 of FIG. 6).

In some implementations, combining fingerprints can include averaging the matched and aligned fingerprints (contributing fingerprints) to obtain one or more representative fingerprints that are averaged fingerprints stored in the fingerprint map for a location that represents the contributing fingerprints. In some implementations, Gaussian processing or other techniques can be used to average CIR data of the contributing fingerprints to, e.g., smooth variations in the set of fingerprints using a radius that is dependent on a density of fingerprints at the location, to replace the set of fingerprints with one or more representative fingerprints. For example, in some implementations, the averaging technique can define a radius around a particular location as described above, and CIR data is obtained from fingerprints within this radius. The CIR values can be averaged based on a weighting function (e.g., a Gaussian function). This weighting function assigns higher importance to closer fingerprints to the location and gradually reduces the influence of those further away. The result is a single, representative fingerprint associated with that location that reflects the overall trend in the surrounding area, capturing a smoother and more robust representation compared to simply averaging equally. In some implementations, a representation of a Gaussian distribution and a confidence level (e.g., as a Gaussian Mixture Model) can be used to represent the combined fingerprints in the map, and/or other averaging techniques or similar techniques can be used to reduce the fingerprint data in the fingerprint map.

In some implementations, combining the matched and aligned fingerprints in the fingerprint map can include aggregating the fingerprints into clusters, e.g., each set of matched and aligned fingerprints is aggregated into a respective cluster. Each cluster is represented by the representative fingerprint that is a cluster fingerprint that has a cluster location in the fingerprint map. The cluster fingerprint is stored in the fingerprint map in association with the cluster location, instead of storing the fingerprints of the set in the map. The determination of cluster size (e.g., how many of the matched and aligned fingerprints of the set are included in a cluster) can depend on a local density of data points and the environmental context (e.g., urban, semi-urban, or rural for higher to lower density). This clustering can reduce uneven fingerprint distribution and also increase the overall quality and reliability of the location data. Block 410 can be followed by block 412.

In block 412, the fingerprint map is updated or is replaced with a newly-generated fingerprint map, at one or more later times. For example, in some implementations, after a fingerprint map has been generated as described above in blocks 402-410 of method 400, a new fingerprint map can be later generated using method 400, e.g., based on more recently collected cellular signals, and the new fingerprint map can replace the old fingerprint map. In some implementations, the existing fingerprint map can be updated with one or more new fingerprints that are generated based on more recently collected cellular signals. In some implementations, a fingerprint map can be replaced or updated based on one or more conditions occurring, e.g., a time period elapsing (e.g., periodically) or according to other conditions. For example, every week, additional location fingerprints can be collected by user devices and the fingerprint map can be updated; and every month, a new fingerprint map with new collected fingerprints can replace the entire existing fingerprint map. The period of update and/or replacement of the fingerprint map can vary based on the geographic area depicted in the map. For example, a fingerprint map for an area having more activity (lots of moving or changing persons, vehicles, objects) can be updated or replaced more frequently than a map for an area having less activity.

In some implementations, one or more blocks of method 400 can be repeatedly and/or periodically performed. For example, location fingerprints can be repeatedly and periodically generated in block 402, and/or fingerprint maps can be repeatedly and/or periodically updated or replaced in block 412. For example, for block 402, a user device can collect 100 signal measurements for a period of five minutes each day, and upload the measurements (or generated fingerprints) to a server system which updates the fingerprint map with newly generated location fingerprints based on the uploads. In some implementations, a larger or smaller amount and/or rate of measurements can be made by the user device for fingerprint generation in block 402, e.g., 100 measurements every five seconds, a measurement made every second for five minutes, etc. Power consumption vs. accuracy can be balanced in the rate of measurements performed by a user device, and different user devices can have different measurement rates. In some implementations, the period between collection of CIRs by a user device can vary based on the geographic area depicted in the associated fingerprint map (and the activity within the area), similarly as described above.

It should be noted that generating location fingerprints as in block 402 can be performed partially or completely simultaneously for different user devices and/or different geographical locations, such that method 400 (or portions thereof) can be performed multiple times at least partially simultaneously for different user devices and/or for different geographic locations, and/or a sequential determination for one or more different user devices and/or locations can be performed. Similarly, multiple different fingerprint maps can be generated or updated partially or completely simultaneously, e.g., for different geographic areas or regions.

Generation of a Location Fingerprint using a User Device

FIG. 5 is a block diagram illustrating a method 500 to generate a location fingerprint for a geographic location of a device, according to some implementations. In some implementations, some or all of method 500 can be implemented, for example, by one or more user devices or client devices, e.g., client devices 120, 122, 124, or 126 as shown in FIG. 1. In some implementations, some or all of method 500 can be implemented on one or more server systems, e.g., server system 102 as shown in FIG. 1, and/or on both server system(s) and client device(s) (e.g., some blocks, or portions of blocks, on server devices and some blocks (or portions of blocks) on client devices). In described examples, the implementing system includes one or more digital processors or processing circuitry (“processors”), and one or more storage devices (e.g., a database or other storage). In some implementations, different components of one or more servers and/or clients can perform different blocks or other parts of the method 500. Some implementations can have one or more blocks of method 500 performed by one or more other devices (e.g., other client devices or server systems) that can send results or data to a first device that performs other blocks.

Blocks of method 500 are only performed if permission is obtained by user(s) who owns or are associated with the client device(s) being used.

Method 500 can be used to generate location fingerprints associated with geographic locations that can be used to accurately determine the locations of user devices in methods described herein. For example, method 500 can be used in block 402 of method 400 of FIG. 4, to generate location fingerprints that populate a fingerprint map. Method 500 can be used in block 604 of FIG. 6, to provide a particular location fingerprint for user device localization, e.g., to be compared to fingerprint maps to determine the location of the device.

Method 500 describes examples of generating a single location fingerprint for a single user device. Method 500 can be repeated for different user devices, at different geographic locations, and/or at different times to generate respective location fingerprints for those devices, locations, and/or times.

Method 500 may begin at block 502. In block 502, channel impulse responses (CIRs) are obtained for cellular signals from a set of multiple cellular nodes near the geographic location of a user device. Each CIR represents a response to a cellular radio signal based on the environment at the location of the user device. A CIR measures signals received on line-of-sight (LOS) paths to a cellular node, and signals received on multipaths in which there is no LOS and the signals may bounce off buildings or other objects in the environment. For example, if a signal is received from multiple paths (multipath), the resulting CIR includes a sum of the effects of all paths (e.g., multiple peaks if paths are of very different lengths, overlapping peaks if paths are close in range (delay), etc.). In some implementations, if a physical cellular transmitter or tower transmits a respective cellular signal on each of multiple cellular channels (multiple RF channels), each such signal can be a single or separate cellular node. The CIRs of the set of cellular nodes can be determined by components of the user device based on received cellular signals. Each CIR can include a number of time samples. For example, a cellular modem of the user device can obtain (e.g., measure) the CIR for each node over a periodic signal segment with period T. The cellular modem may obtain CIRs over multiple such periods in order to refine its CIR measurement, e.g., as described in block 506. In some implementations, other characteristics of, or information relating to, the cellular signals can also be collected or determined in block 502 (e.g., carrier-to-noise ratio (CNR), pseudorange, Doppler shift, carrier phase, etc.).

The collection of the set of CIRs by the user device can be initiated based on one or more conditions, such as a request from a server system, one or more time conditions (e.g., periodically after every particular time period), location conditions (e.g., being moved a threshold distance from the last location and/or moving into a new designated geographic area), and/or other conditions (e.g., user input from a user of the user device, a command from a map application or other application executing on the user device or from a different device, etc.).

In some implementations, the CIRs measured by the user device can be a set of CIRs collected at the same time by that user device. When collected at the same time, the CIRs are all synchronized with each other. However, in some implementations, some CIRs in the set of CIRs may be collected at different times. For example, the user device may not be capable of measuring all the CIRs from all the signals from the cellular nodes at the same time, and thus is required to collect CIRs from some signals, then collect CIRs from other signals at a later time, and so on until a full set of CIRs is collected (e.g., each collection being in rapid succession). In such cases, there may be clock drift that occurs between CIRs collected at different times. Therefore, the clock drift can be tracked by the user device over all the collections of the CIRs, allowing synchronization as described below in block 504. For example, the tracking of clock drift can include tracking of clock drift information, which includes measurements of the cellular signal, and this information can be determined and stored in block 502, as described below for block 504.

In some implementations or cases, the set of cellular nodes from which a respective user device collects CIRs is a set of stable and synchronized nodes that allows greater accuracy in location determination. For example, the set of cellular nodes to use can be obtained from a synchronized nodes database, such as synchronized nodes database 114 of FIG. 1. Examples of generating a database of synchronized nodes are described above with reference to method 300 of FIG. 3. For example, a cluster of synchronized nodes that is associated with the geographical location can be accessed from the database and used as the set of nodes. In some implementations or cases, CIRs can be collected from cellular nodes that have unknown synchronization, and this data can be used to determine whether these nodes are synchronized (and this synchronization status can be stored in synchronized nodes database 114).

The geographical location associated with the collected set of CIRs can be determined using any one or combination of multiple location-finding techniques that can determine the approximate locations of the collecting user device, similarly as described below with respect to block 604 of FIG. 6. For example, global positioning signals (GPS) or other GNSS signals detected by the user device can be used if available, and/or previous communications of the user device with one or more cellular nodes over a time period (e.g., the last several minutes) (where the locations of the cellular nodes are known). In some implementations, the approximate location can be determined based on the CIRs that the user device collects in block 502. In some implementations, the approximate location may be refined, e.g., at a server system, via sensor fusion (fusing sensor data from GNSS, accelerometer, magnetometer, gyroscope, WLAN signals and other data from one user device over time) and/or via collaborative SLAM (Simultaneous Localization and Mapping), in which anonymized sensor data from multiple user devices interact to jointly estimate more accurate localizations of each device over time. In some implementations, anonymized and permissioned obtained location fingerprints from multiple user devices (generated as described herein) can be included in the collaborative SLAM technique, e.g., to detect when two devices were in a same or similar location when they collected these fingerprints. For example, correlation values can be determined between two fingerprints to determine if the fingerprints are in the same location, similarly as described below in blocks 608 and 610 of FIG. 6. A confidence level can also be associated with the geographic location as described below with respect to block 604 of FIG. 6. Block 502 may be followed by block 504.

In block 504, the CIRs that were collected from multiple cellular nodes in block 502 are synchronized (aligned). In many cases, CIRs were collected at different times as described above, such that clock drift may have occurred to cause CIRs that were collected at different times to be out of synchronization. CIRs collected at the same geographic location and at different times can show time shifts. These shifts may result from unique clock biases in each CIR caused by changes in the clock of the user device (clock drift) over time. The time shifts can be corrected to provide aligned CIR samples for a fingerprint, e.g., CIR samples that are expressed via the same clock. For example, the CIRs can be synchronized by correcting timing errors in the signals. For example, the multiple cellular signals can include multiple signal segments that have been collected from various Cell nodes at kT, where k is a positive integer and k=0 represents the first set of collected CIRs. The length of a signal segment can be variable. Each CIR may correspond to one of the signal segments. In some examples, CIRs can be collected from a subset of the cell nodes at k=0, then a different (but not necessarily exclusive, and possibly empty) subset k=1, and so on.

When accumulating a CIR of a particular cellular node for multiple signal segments, each CIR, corresponding to one of the signal segments, is shifted in time and frequency compared to a reference CIR (e.g., initial CIR) (obtained from the reference (e.g. initial) signal segment) of that cellular node. To compensate for these time and frequency mismatches, the user device can track clock drift information for a cellular node, which can include high-resolution pseudorange measurements and pseudorange rate measurements of that cellular node, and use the measurements to apply time and frequency corrections to achieve alignment of all CIRs. In some implementations, clock drift information for multiple cellular nodes can be tracked. In some implementations, due to the tight synchronization of multiple cellular nodes (which share a similar clock drift), the tracking of clock drift information for one or several particular cellular node(s) can be used to perform the necessary time and frequency corrections for the accumulation of other CIRs (e.g., all the CIRs) corresponding to other (e.g., all) cellular nodes in a particular fingerprint. These particular cellular nodes can be chosen for various reasons, such as having the strongest signal, exhibiting less multipath (less distorted peak), etc. This cross-synchronization allows, for example, to synchronize CIRs of nodes for which the tracking of clock drift is achievable or performable only in a subset of the segments (e.g., allows correction of clock drift for a node that appears in only a subset of collected segments), and also enables reduction in the use of computational resources (e.g., memory, processing, etc.) used for tracking.

In some implementations, block 504 can be performed by the user device collecting the CIR data. In some implementations, block 504 can be performed by a server system, e.g., based on CIR data and clock (e.g., clock drift over time) information collected by the user device in block 502 and sent to the server system. Block 504 may be followed by block 506.

In block 506, additional CIRs may be obtained by the user device at the geographic location sampled in block 502 and the CIRs can be refined by using accumulated, additional CIR data from multiple cellular signals at the same location (e.g., over time). For example, block 506 can be performed at a later time than block 502. The additional CIR data can be used to refine the CIRs collected in block 502, to provide a more accurate location fingerprint for the geographic location by accumulating the additional CIR data over time. For example, the later time can be about 0.1 to 5 seconds after the previous CIR collection of block 504, or other short time period. Block 506 can refine the CIRs using the additional data by, for example, combining signal samples (coherent accumulation), e.g., by merging CIR samples separately for each cellular node, taking into account slight timing differences (clock drift) that occur over time by correcting timing errors (clock drift). This can be considered stacking signal information from each node including compensating for minor timing variations. The time shifts can be corrected to allow accurate merging of the CIR samples. This correction causes each signal segment to be aligned in time (taking into account both clock drifts and differences in collection times of the CIRs being accumulated) with all previous corresponding segments from that node; hence, all accumulated CIRs are synchronized and can be accumulated coherently. Thus, blocks 502-506 provide alignment between CIRs of different nodes, and CIRs measured from the same nodes. Block 506 may be followed by block 508.

In block 508, a particular CIR is selected from the collected set of CIRs, where the particular CIR has the highest sampling rate among the collected CIRs, and, if appropriate, the other CIRs in the set are upsampled to match the particular CIR. For example, different cellular nodes may have varying bandwidths, and the number of samples in each CIR may differ. Block 508 addresses this case by upsampling the CIRs from lower sampling nodes to match the highest sampling rate. Block 508 may be followed by block 510.

In block 510, a location fingerprint is generated for the geographic location associated with the collected CIRs, where the location fingerprint includes multiple CIRs. For example, the location fingerprint can be represented as the CIRs of the set of cell nodes collected by the user device at the geographic location. The location fingerprint can be generated at various times in different implementations; for example, in some implementations, the location fingerprint can be generated using initial CIRs obtained in block 502 and then modified and/or refined based on additional CIRs obtained in block 504 and/or block 506 (and/or at later times). In some implementations, the location fingerprint can be generated after obtaining additional CIRs in block 506 (and/or later modified and refined based on further additional CIRs obtained at later times).

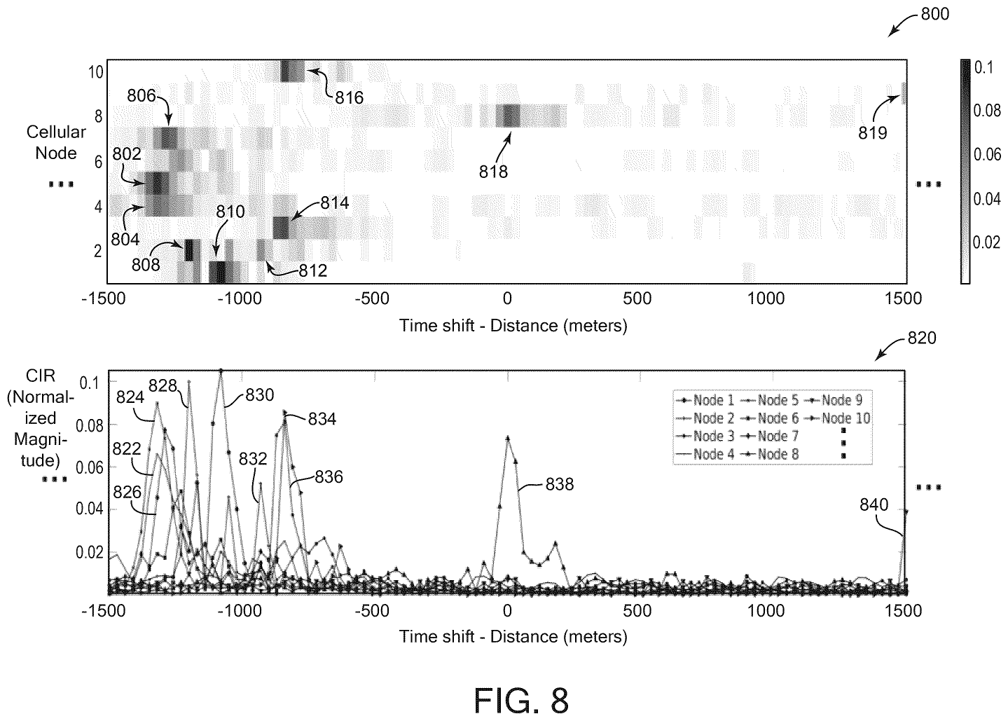

In some implementations, the fingerprint can be represented by a matrix that includes rows (m), where each row represents corresponding samples of each of the multiple CIRs in the fingerprint (e.g., the row includes a sample of each CIR, where these samples have a corresponding time delay), where the number of rows (m) corresponds to a number of samples in a signal segment; and columns (n), where each column represents a CIR of a different respective cellular node in the set of cellular nodes. Alternatively, the columns and rows can be reversed from this configuration, such that the columns can each represent the corresponding samples of the CIRs, and rows can each represent a CIR of a respective cellular node (e.g., as in the example of plot 800 of FIG. 8) (columns and rows can also be referred to as linear arrays of a particular dimension, e.g., of a 2-dimensional matrix). Block 510 may be followed by block 512.

In block 512, the location fingerprint can be modified to include a relevant portion of the fingerprint data and other portions of the fingerprint data can be discarded to provide a smaller-sized fingerprint for greater storage and transmission efficiency. For example, the location fingerprint can be packaged so that it occupies a smaller amount of storage, e.g., is compressed to allow more efficient storage and access, by discarding less informative portions of the fingerprint data for the methods described herein. In some implementations, determining the relevant portion includes selecting samples of the location fingerprint that correspond to the most significant signal delays (m_select) (each sample being measured as a delay from the first sample). This selection can be based on maximum power delay (m_max_power), that represents the sample shift where the strongest signal peak occurs across all CIRs (all cellular nodes). The selection can include choosing samples that are close to the peak power, m_max_power, within a maximum delay, max_delay_m, on both sides. These samples arc within narrower time windows of the CIRs.

This technique collects the most useful samples for identifying the location fingerprint, especially those samples near the peak delays, and the other samples can be discarded to make the fingerprint size more manageable. Because of these time shifts and the circular pattern of a location fingerprint, which comes from the repeating nature of the signal segment, the relevant portion of the fingerprint may include elements from both the start and end of the signal segment's delay span. This makes the fingerprint appear to be shifted along a time axis when compared to another fingerprint. Despite the relevant portion of the fingerprint data representing a narrower time window than the full fingerprint, the relevant portion may still span a significant geographical area, e.g., potentially several kilometers wide, to capture the information from all cellular nodes in the area.

In some implementations, to further compress the fingerprint, each CIR may be rotated (shifted) by a varying number of samples in order to align its relevant portion (e.g., its peaks) with the relevant portions (e.g., peaks) of other CIRs from the other nodes within a narrower time window. The offset information (direction and amount) of each CIR can be stored with or associated with the fingerprint to allow decompression. All of the CIRs are cropped to the narrower time window in which the relevant portions are aligned. The full-width fingerprint can be approximately recreated from the compressed fingerprint in a decompression operation by performing these operations in reverse order, e.g., by adding null data for cropped portions and shifting the samples according to stored offset information. Block 512 may be followed by block 514.

In block 514, the location fingerprint can be normalized. In some implementations, normalization using an L2 approach can be applied to the location fingerprint. This process removes the influence of hardware and some environmental variations and emphasizes the relative delay and power information useful for location-based fingerprinting. Normalization causes all location fingerprints to be comparable regardless of the specific user device used to collect the fingerprint data and how those user devices were used (e.g., whether they are carried in a hand on in a pocket of a user).

### Localization Using a Fingerprint Map to Determine a Geographic Location of a User Device

FIG. 6 is a block diagram illustrating a method 600 to determine a geographic location of a device using cellular signals and a fingerprint map, according to some implementations. In some implementations, some or all of method 600 can be implemented, for example, by one or more client devices 120, 122, 124, or 126 as shown in FIG. 1. In some implementations, some or all of method 600 can be implemented on one or more server systems 102 as shown in FIG. 1, and/or on both server device(s) and client device(s). In described examples, the implementing system includes one or more digital processors or processing circuitry (“processors”), and one or more storage devices (e.g., a database or other storage). In some implementations, different components of one or more servers and/or clients can perform different blocks or other parts of the method 600. Some implementations can have one or more blocks of method 600 performed by one or more other devices (e.g., other client devices or server devices) that can send results or data to a first device that performs other blocks.

Blocks of method 600 are only performed if permission is obtained by user(s) who owns or are associated with the client device(s) being used.

Method 600 can be used to determine a location of a user device using location fingerprints generated for the current location of the user device and location fingerprints previously generated in association with geographic locations. For example, method 600 can use the fingerprint map generated in method 400 of FIG. 4.

Method 600 may begin at block 602. In block 602, a request is received for determination of a particular geographic location of a particular user device that is located at a geographic location. For example, a user of the particular user device may have input the request to provide the current location of the particular user device, e.g., via a navigation application or other application. For example, the user may have opened a map application to display a geographic map of a geographic area in which the particular user device is currently located, and the device shows a precise location of the particular user device on that map. In some implementations, the request is received by a server that determines a location of the particular user device in method 600. In some implementations, the user device receives the request and determines the location, or a server system and user device perform different portions of method 600. Block 602 may be followed by block 604.

In block 604, a particular location fingerprint is obtained for the particular user device. In some implementations, an approximate location of the particular user device can also be obtained. In some implementations, the particular location fingerprint can be generated using method 500 of FIG. 5 described above, e.g., by the particular user device collecting CIRs from multiple cellular nodes in its vicinity and processing that CIR data to form and package the location fingerprint. For example, the particular user device can generate the particular location fingerprint (and send it to a server system for processing in method 600 in some implementations, or perform further processing itself), or the particular user device can send CIR data and other data (e.g., clock data indicating clock drift over time, or clock delay data) to a server system which generates the particular location fingerprint, or other methods can be used.

In some implementations, the approximate location of the particular user device can also be determined, which is a coarse estimate of the geographic location of the particular user device. The approximate location can be determined using any one or combination of multiple techniques. For example, in some implementations the approximate location can be determined based on global positioning signals (GPS) detected by the particular user device if available, and/or based on previous communications of the particular user device with one or more cell nodes over a time period (e.g., the last several minutes), where the locations of the cell nodes are known. In some implementations, the approximate location can be determined based on the CIRs that the user device has collected for the generation of the particular location fingerprint in block 604 as described above, where the CIRs indicate location based on locations of cell nodes. In some implementations, the approximate location can be determined based on the particular location fingerprint generated in block 604, e.g., by referencing a maintained database or map of location fingerprints that are associated with approximate locations, separate from the fingerprint map of FIG. 4 (e.g., the approximate fingerprint database being stored by a server system or user device). Some implementations can use multiple of such techniques to determine the approximate location. In some implementations, the approximate location may be refined, e.g., at a server system, or via sensor fusion (e.g., at user device or server system).

A confidence level can also be obtained for the approximate location that indicates the estimated accuracy of the approximate location. For example, the particular user device can maintain an estimate of its current geographic location and provide an indication of how confident that estimate is. In some examples, a strong detected GPS signal provides a more confident estimate than a weak signal. In further examples, if the location was estimated previously, the longer the time period since the last estimate, the lower the confidence in that estimate. If the user device has not moved since the location estimate, the approximate location is more confident than the case in which the user device has moved. In some implementations, the confidence level indicates the size of the potential geographic area in which the user device could be located; e.g., a particular low confidence level can indicate a current location within a one kilometer radius, and a particular high confidence level can indicate a current location within a 10-meter radius. In some implementations, block 604 can be repeated to provide more accurate CIRs and/or location fingerprints; for example, block 604 can be repeated at smaller time intervals than the standard fingerprint generation (e.g., as in method 500 of FIG. 5) when not determining an accurate location of the particular user device. Block 604 may be followed by block 606.

In block 606, multiple location fingerprints are obtained, where these fingerprints can be map location fingerprints selected from a fingerprint map. For example, the fingerprint map may have been created as described with reference to FIG. 4. In some implementations or cases, a client device (e.g., user device) may have the fingerprint map stored in local memory (e.g., previously received from a server system) and can retrieve the obtained multiple locations from that map. In other implementations or cases, the fingerprint map may be stored by a server system which can be accessed to obtain the multiple location fingerprints in block 606.

In some implementations, the map location fingerprints that are selected from the fingerprint map are a subset of fingerprints in the fingerprint map that are most similar to the particular fingerprint obtained by the device in block 604. For example, in some implementations, map fingerprints having greater than a particular amount or threshold of similarity can be used. In some implementations, the map location fingerprints can be selected for similarity to the particular fingerprint based on characteristics of the fingerprints, such as which cellular nodes have been observed in block 604 and/or other similarity metric that can be used (e.g., by the server) to, for example, prepare a fast nearest-neighbor fingerprint search.

In some implementations, the map location fingerprints can be selected based on an approximate location of the particular user device that may have been obtained in some implementations as described by block 604. In some implementations, the obtained map location fingerprints are a subset of fingerprints stored in the fingerprint map, where the subset is associated with (located in) a geographic area that includes the approximate location of the particular user device. For example, the geographic area can have a radius or size that includes the approximate location. In some implementations, the geographic area can vary in size and be based on the confidence level of the approximate location. For example, if the approximate location of the particular user device has a low confidence level, a larger geographic area can be used to select a larger subset of fingerprints within that larger geographic area in the fingerprint map. If the approximate location has a higher confidence level, a smaller geographic area can be used to select a smaller subset of fingerprints within that smaller geographic area. Block 606 may be followed by block 608.

In block 608, the particular location fingerprint is compared to the map location fingerprints (e.g., “map fingerprints”) obtained in block 606 to determine a match score for each of the map location fingerprints, and a matched location fingerprint is selected from these map fingerprints based on the match scores. In some implementations, the comparing operations include using a super-correlation technique to compare CIRs of each map fingerprint to a CIR of the particular fingerprint.

A match score is determined for each of the map location fingerprints that indicates how closely the map fingerprint matches the particular location fingerprint, and a matched location fingerprint is selected from the map location fingerprints based on the match score. In some implementations, the super-correlation technique can be used to compare the fingerprints and determine the best match by determining or estimating an offset (shift) in the samples of one of the compared CIRs that maximizes the correlation and thus results in the highest match score. For example, fingerprints created at different times may be subject to a specific circular shift based on various factors, and this shift can appear as a linear offset between processed fingerprints that can be compensated for.

In some implementations, the super-correlation technique can include shifting CIR samples of either the particular fingerprint or the compared map fingerprint to multiple positions in time forward and/or back, e.g., applying a respective linear offset to the CIRs of the fingerprint, to create multiple versions of the fingerprint. The CIRs of the other of the compared fingerprints are not shifted. For example, the CIRs of the particular location fingerprint can be shifted to provide multiple versions of those CIRs which are compared to the unshifted CIRs of each of the map location fingerprints. Alternatively, the CIRs of each of the map location fingerprints can be shifted and compared to the unshifted CIRs of the particular location fingerprint.

The correlations are calculated by comparing each shifted fingerprint version to the unshifted fingerprint to determine a respective correlation value, which indicates the magnitude of correlation of the CIRs of the compared fingerprints. The match score can be based on that correlation value (magnitude of correlation). One of the map location fingerprints is selected that provides maximum correlation (e.g., highest correlation value or match score) to the particular fingerprint.

For example, if the fingerprints are represented as matrices as described above, for each shifted version, a correlation can be calculated as a sum of correlations between each column in one unshifted matrix with its counterpart in the other shifted matrix. In some examples, the correlation between two columns may be the dot product of these two columns.

In some implementations, the super-correlation takes into account the circular nature of fingerprints, e.g., by wrapping fingerprints over a segment period which can provide more accurate match scores. The comparison of shifted fingerprints as performed herein provides a robust and accurate comparison between fingerprints since it removes offsets that may often occur in measured CIRs.

In some implementations, a Fast Fourier Transform (FFT) is used in the correlation technique to determine the shift position (and fingerprint) having maximum correlation with greater efficiency. The FFT provides a full correlation vector between a map fingerprint and the particular fingerprint. The highest correlation peak in this vector is selected as the respective correlation value for the compared fingerprints, and the match score for the compared fingerprints can be based on that correlation value similarly as described above. Thus, the FFT can provide a correlation value between the particular fingerprint and a map fingerprint without having to explicitly construct the different versions of one of the compared fingerprints described above. An FFT-based technique can inherently account for the circular aspect of fingerprints when maintained at the original signal segment size. In some implementations, where a fingerprint is truncated and requires linear correlation computation, the fingerprint can be provided with zero-padding on both sides such that the FFT size becomes at least twice as large as that of the truncated fingerprint, facilitating accurate and efficient correlation analysis. Block 608 may be followed by block 610.

In block 610, a matched geographical location that is associated with the matched location fingerprint is determined. This matched location can be determined from the fingerprint map that associates locations with fingerprints. In some implementations, the match scores resulting from the fingerprint comparisons of block 608 can be provided and/or stored as a continuous heatmap over the geographical area in which the particular user device is located, where each point on the heatmap represents a potential location of the user device having an associated confidence level derived from the match score of each location.

In some implementations, a maximum-likelihood approach can be used to select either the highest likelihood point or a cluster of points with the highest likelihood density for the location of the particular user device. In some implementations, the match scores resulting from the comparisons of block 608 can be combined with data from other sensors through algorithms such as Kalman filters, particle filters, or vector graphs, to determine the location of the particular user device. Block 610 may be followed by block 612.

In block 612, the matched geographic location is caused to be output by the particular user device as the requested particular geographic location of the particular user device. For example, the particular user device can display a map or other representation of the matched geographic location.

### Creation and Population of a Cellular Signal Configuration Database

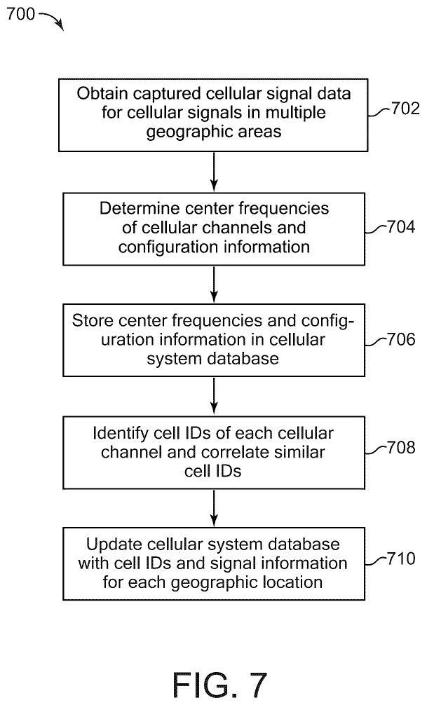

FIG. 7 is a block diagram illustrating a method 700 to provide a cellular system database that includes cellular signal data for geographic locations to use in determination of device locations, according to some implementations. In some implementations, some or all of method 700 can be implemented, for example, by one or more client devices 120, 122, 124, or 126 as shown in FIG. 1. In some implementations, some or all of method 700 can be implemented on one or more server systems 102 as shown in FIG. 1, and/or on both server device(s) and client device(s). In described examples, the implementing system includes one or more digital processors or processing circuitry (“processors”), and one or more storage devices (e.g., a database or other storage). In some implementations, different components of one or more servers and/or clients can perform different blocks or other parts of the method 700. Some implementations can have one or more blocks of method 700 performed by one or more other devices (e.g., other client devices or server devices) that can send results or data to a first device that performs other blocks.

Method 700 can be used to determine and store accurate data related to cellular signals that are present in particular geographic areas and characteristics of those signals. Such data can be populated and stored in a database that can be accessed to use cellular signal information in various methods described herein, e.g., to enable accurate determination of user device location. For example, method 700 can generate a geographical cellular system database (e.g., database 112 of FIG. 1) that can be used by method 300 of FIG. 3 and/or method 400 of FIG. 4.

Method 700 may begin at block 702. In block 702, cellular signal data is obtained for cellular signals that have been captured in multiple geographic areas. In some implementations, the cellular signal data can include cellular channel characteristics. For example, the channel characteristics can be obtained in any of multiple ways. In some implementations, user devices can be instructed to obtain the channel characteristics in geographic areas and, in some implementations, send the characteristics to a system implementing method 700 (e.g., a server system). For example, the channel characteristics can include signal type (e.g., Long-Term Evolution (LTE), New Radio (NR), etc.), center frequency of the cellular signal, country code, network code, cell identity (cell ID) (global), physical cell ID (local), bandwidth, duplexing mode (frequency division multiplex (FDD) or time division multiplex (TDD), signal strength of the channel estimation reference signal, predefined numerology, etc. In some implementations, approximate or estimated geographical locations of cellular nodes can also be determined based on the obtained cellular signal information and other information, e.g., using any of multiple techniques (e.g., GPS signals, previous communications of a user device with one or more cellular nodes over a time period such as the last several minutes, etc.). In some implementations in which such channel characteristics are obtained from devices, block 702 can be followed by block 710, described below. Block 702 may be followed by block 704.

In block 704, center frequencies of cellular channels and configuration information are determined. For example, the center frequencies may have been obtained by user devices directly in block 702. In some implementations, the configuration information associated with the cellular channels can include one or more of bandwidth, duplexing mode (e.g., TDD or FDD), and/or numerology or resource allocation scheme. Block 704 may be followed by block 706.

In block 706, the center frequencies and configuration information are stored in a geographic cellular system database. In some implementations, the database can provide the center frequency and configuration information for each identified location, e.g., locations identified by latitude, longitude, altitude, etc. In some implementations, the database can be implemented by a server system, or can be implemented on one or more client devices. Block 706 may be followed by block 708.

In block 708, cell IDs are identified for each determined cellular channel, and similar cell IDs are correlated. For example, cell ID information may have been received with the obtained cellular signal information, and this information received from multiple devices can be cumulatively searched to determine cell IDs for all the detected channels. The determined cellular channels can include multiple realizations of the same center frequency (i.e., detected from multiple user devices) such that the cell ID having the greatest correlation for a particular channel is assigned to that channel. This correlation enhances cell ID detection and reduces false positives caused by rapidly varying cell IDs. Other information can also be determined, such as signal type, cell provider information associated with the cell IDs (e.g., based on information from other databases, etc.) In some implementations, approximate or estimated geographical locations of the cellular nodes can also be determined based on the obtained cellular signal information and other information, e.g., using any of multiple techniques (e.g., GPS signals, previous communications of a user device with one or more cellular nodes over a time period such as the last several minutes, etc.). Block 708 may be followed by block 710.

In block 710, the cellular system database is updated with cellular signal data obtained in block 702 and/or blocks 704-708 for each geographic location. In some implementations, the signal information can include the signal type (e.g., 3G, 4G, 5G, etc.), center frequency bandwidth, duplex mode, cell provider, estimated geographic location of the cell IDs, etc. The data in the cellular system database can be retrieved for one or more blocks in the methods described herein in which a user device measures cellular signals, e.g., for synchronization assessment of cellular nodes and signals (e.g., FIGS. 3 and 4) and/or fingerprint generation for fingerprint mapping or localization of a user device (e.g., FIGS. 4-6).

In various implementations, various blocks of methods 300, 400, 500, 600, and/or 700 may be combined, split into multiple blocks, performed in parallel, or performed asynchronously. In some implementations, one or more blocks of methods 300, 400, 500, 600, and/or 700 may not be performed or may be performed in a different order than shown in FIGS. 3, 4, 5, 6, and 7. Methods 300, 400, 500, 600, and/or 700, or portions thereof, may be repeated any number of times using additional inputs, e.g., additional cellular signal data is received or otherwise obtained.

FIG. 8 is a diagrammatic illustration showing two example plots 800 and 820 that represent an example location fingerprint as described in some implementations herein. Other representations of location fingerprints can also be used.

Plot 800 is a heatmap style of representation in which a location fingerprint is presented in the format of a gray-shaded heat map that shows CIR signal strengths of signals measured by a device from multiple cellular nodes. The x-axis represents the distance (time delay) between a cellular node (transmitter) and a device that measured the cellular signal. The distance range shown for the x-axis in plot 800 is a portion of the full range of time shifts (distances) over which signal samples may be collected. For example, the distances can be pseudorange measurements based on time of signal propagation, which can include a range measurement that incorporates adjustments for clock bias between the transmitter and receiver clocks (the adjustments providing positive and negative values for distance). CIR samples are collected at specific intervals (e.g., sampling time, delay, or time shift), and the equivalent to this time shift is indicated as a pseudorange distance. The y-axis represents different cellular nodes, indicated as the cell ID of each cellular node (increasing cell ID values). The cell ID range shown in plot 800 is a portion of the full range of cell IDs that may be detected.

The shade intensity of each point (CIR sample) in the plot represents the power strength of a detected signal for that combination of cellular node and time shift (distance). A higher intensity (darker shade) indicates a stronger cellular signal received from that specific cellular node (cell ID) at a particular distance (time shift). In plot 800, several CIR samples are represented and include sample magnitudes 802, 804, 806, 808, 810, 812, 814, 816, 818, and 819 that indicate strong cellular signals at those particular time shifts. These sample magnitudes provide a unique fingerprint for the particular location of the user device that collected the signals. In some implementations, the plot 800 (or a similar plot, and/or a plot with reversed x and y axes) can correspond to a matrix representation of a fingerprint as described above.

Plot 820 is a representation in which a location fingerprint is presented in the format of measured CIR magnitudes for multiple cellular nodes. The x-axis represents the distance (time delay) between a cellular node and a device that measured the cellular signal, similarly to plot 800, where the distance range shown is a portion of the full range of distances over which signal samples may be collected. The y-axis represents detected CIR magnitudes that have been normalized. The higher a point is along the y-axis, the stronger the cellular signal received at its distance (time shift).

As shown in plot 820, several graphs represent the signals collected from particular cellular nodes, where each graph corresponds to a different cellular node. For example, measured signals from cellular nodes labeled 1-10 are shown as different graphs. These graphs show peaks that correspond to the strongest sample points shown in plot 800. For example, peak 822 (Node 4) corresponds to sample magnitude 804, peak 824 (Node 5) corresponds to sample magnitude 802, peak 826 (Node 7) corresponds to sample magnitude 806, peak 828 (Node 2) corresponds to sample magnitude 808, peak 830 (Node 1) corresponds to sample magnitude 810, peak 832 (Node 2) corresponds to sample magnitude 812, peak 834 (Node 10) corresponds to sample magnitude 816, peak 836 (Node 3) corresponds to sample magnitude 814, peak 838 (Node 8) corresponds to sample magnitude 818, and peak 840 (Node 9) corresponds to sample magnitude 820.

When CIRs are aligned in the methods described herein (e.g., in block 408 when combining location fingerprints for a fingerprint map for block 410 of FIG. 4, or when comparing a particular location fingerprint to map location fingerprints in block 608 of FIG. 6), the CIRs can be shifted along the distance (time shift) axis so that the strongest peaks are approximately aligned. In some examples, when a fingerprint is modified to be compressed (e.g., as described in block 512 of FIG. 5), the rows of plot 800 can be shifted horizontally varying amounts such that their darkest portions (e.g., peaks) approximately align vertically, a narrower time window can be designated that includes the aligned darkest portions, and the portions of the CIRs outside the narrower time window can be cropped to reduce the size of the fingerprint. Applying the opposite operations allows the fingerprint to be decompressed.

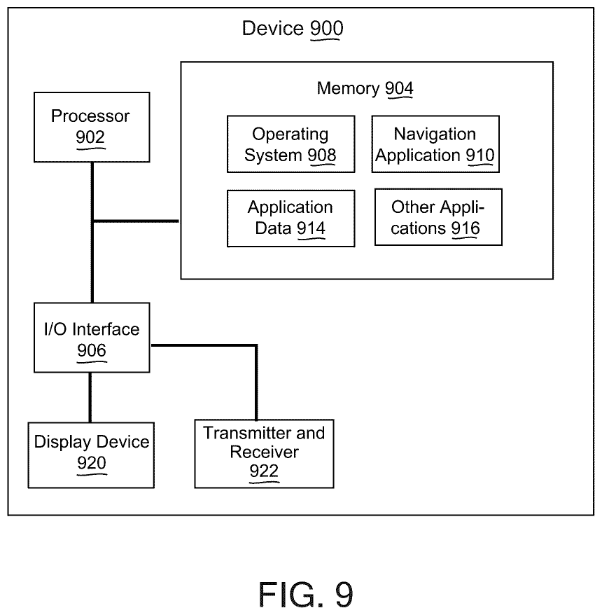

FIG. 9 is a block diagram of an example device 900 which may be used to implement one or more features described herein. In some examples, device 900 may be used to implement a client device, e.g., any of client devices 120-126 and 140 shown in FIG. 1. The device 900 may for example be advantageously embodied in a client device, such as a smartphone, tablet, personal computer, headphones, or PDA. Alternatively, device 900 can implement a server device, e.g., server device 104. In some implementations, device 900 may be used to implement a client device, a server device, or both client and server devices. Device 900 can be any suitable computer system, server, or other electronic or hardware device as described above.

One or more methods described herein can operate in several environments and platforms, e.g., as a standalone computer program that can be executed on any type of computing device, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.), a program run on a web browser, etc. In one example, all computations can be performed within the mobile app (and/or other apps) on the mobile computing device. In another example, a client/server architecture can be used, e.g., a mobile computing device (as a client device) sends input data (e.g., cellular signal data) to a server device and receives from the server the output data (e.g., current location data to be output by a display device of the client device). In another example, computations can be split between the client device and one or more server devices.

In some implementations, device 900 includes a processor 902, a memory 904, and input/output (I/O) interface 906. Processor 902 can be one or more processors and/or processing circuits to execute program code and control basic operations of the device 900. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 902 may include one or more co-processors that implement neural-network processing. In some implementations, processor 902 may be a processor that processes data to produce probabilistic output, e.g., the output produced by processor 902 may be imprecise or may be accurate within a range from an expected output. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 904 is typically provided in device 900 for access by the processor 902 and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 902 and/or integrated therewith. Memory 904 can store software operating on the server device 900 by the processor 902, including an operating system 908, navigation application 910 (e.g., which may be the same as navigation application 106 of FIG. 1), application data 914, and other applications 916. Other applications 916 may include applications such as a data display engine, image editing and/or display engine, notification engine, social networking engine, media display applications, communication applications, web hosting engines or applications, media sharing applications, etc. In some implementations, navigation application 910 can include instructions that enable processor 902 to perform functions described herein, e.g., some or all of blocks of method 300 of FIG. 3, method 400 of FIG. 4, method 500 of FIG. 5, method 600 of FIG. 6, and/or method 700 of FIG. 7. In some implementations, cellular signal data received from devices, databases, and other data used in techniques described herein can be stored as application data 914 or other data in memory 904, and/or on other storage devices of one or more other devices in communication with device 900.

Any software in memory 904 can alternatively be stored on any other suitable storage location or computer-readable medium. In addition, memory 904 (and/or other connected storage device(s)) can store one or more messages, user preferences, one or more databases, taxonomies, electronic encyclopedia, dictionaries, digital maps, knowledge bases, grammars, and/or instructions and data used in the features described herein. Memory 904 and any other type of storage (magnetic disk, optical disk, magnetic tape, or other tangible media) can be considered “storage” or “storage devices.”

I/O interface 906 can provide functions to enable interfacing device 900 with other systems and devices. Interfaced devices can be included as part of the device 900 or can be separate and communicate with the device 900. For example, network communication devices, storage devices (e.g., memory and/or database), and input/output devices can communicate via I/O interface 906. In some implementations, the I/O interface can connect to interface devices such as input devices (keyboard, pointing device, touchscreen, microphone, camera, scanner, sensors, etc.) and/or output devices (display devices, speaker devices, printers, motors, etc.). In some implementations, hardware used for components of server device 104 and/or client devices 120-126 of FIG. 1 can be included in I/O interface or other connected components of device 900.

Some examples of interfaced devices that can connect to I/O interface 906 can include transmitter and receiver components 922 that enable device 900 to communicate cellular signals and process such signals as described herein. For example, components 922 can provide CIR data from cellular signals as described in methods herein. One or more display devices 920 can be used to display content, e.g., images, video, and/or a user interface of an application. Display device 920 can be connected to device 900 via local connections (e.g., display bus) and/or via networked connections and can be any suitable display device. Display device 920 can include any suitable display device such as an LCD, LED, or plasma display screen, CRT, television, monitor, touchscreen, 3-D display screen, or other visual display device. Display device 920 may also act as an input device, e.g., a touchscreen input device. For example, display device 920 can be a flat display screen provided on a mobile device, multiple display screens provided in glasses or a headset device, or a monitor screen for a computer device. The I/O interface 906 can interface to other input and output devices such as one or more microphones that can be used to capture audio, speakers that can output audio based on audio data. one or more cameras which can capture images and/or detect gestures. Other input and output devices can include sensors for detecting gestures, global positioning sensors (GPS), etc.

Any software in memory 904 can alternatively be stored on any other suitable storage location or computer-readable medium. Memory 904 and any other type of storage (magnetic disk, optical disk, magnetic tape, or other tangible media) can be considered “storage” or “storage devices.”

For case of illustration, FIG. 9 shows one block for each of processor 902, memory 904, I/O interface 906, and software blocks 908-916. These blocks may represent one or more processors or processing circuitries, operating systems, memories, I/O interfaces, applications, and/or software modules. In other implementations, device 900 may not have all of the components shown and/or may have other elements including other types of elements instead of, or in addition to, those shown herein. While some components are described as performing blocks and operations as described in some implementations herein, any suitable component or combination of components of environment 100, device 900, similar systems, or any suitable processor or processors associated with such a system, may perform the blocks and operations described.

Methods described herein can be implemented by computer program instructions or computer code, which can be executed on a computer. For example, the code can be implemented by one or more digital processors (e.g., microprocessors or other processing circuitry) and can be stored on a computer program product including a non-transitory computer-readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

Although the description has been described with respect to particular implementations thereof, these particular implementations are merely illustrative, and not restrictive. Concepts illustrated in the examples may be applied to other examples and implementations.

In situations in which certain implementations discussed herein may collect or use personal information about users (e.g., user data, such as image, speech, and other data, information about a user's social network, user's location and time at the location, user's biometric information, user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information specifically upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user device's geographic location may be generalized to a larger region so that the user's particular location cannot be determined. For example, when location fingerprints are collected from multiple users to build a fingerprint map, the data may be anonymized and aggregated to prevent the identification of any individual user's contribution or travel patterns. A user's identity may be treated so that no personally identifiable information can be determined. As another example, a user device's specific geographic location may be generalized to a larger region so that the user's particular location cannot be determined, or data may be used only in an aggregated, statistical model.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method comprising:
obtaining a plurality of location fingerprints, wherein each location fingerprint identifies and is associated with a respective geographic location and is based on cellular signal characteristics determined at the respective geographic location, the cellular signal characteristics including multiple channel impulse responses (CIRs) for each location fingerprint for signals received from a plurality of cellular nodes by one or more devices located at the respective geographic location;
forming a fingerprint map that references the obtained location fingerprints;
receiving a request for determination of a particular geographic location of a particular user device that is located at the particular geographic location;
obtaining a particular location fingerprint generated for the particular user device that indicates particular cellular signal characteristics determined at the particular geographic location, the particular cellular signal characteristics including particular CIRs for particular signals received from multiple cellular nodes by the particular user device located at the particular geographic location;
comparing the particular location fingerprint to multiple respective location fingerprints in the fingerprint map;
selecting a matching location fingerprint of the multiple respective location fingerprints in the fingerprint map based on the comparing; and
causing a respective geographic location associated with the matching location fingerprint to be output as the particular geographic location of the particular user device.

2. A computer-implemented method comprising:
obtaining, by at least one processor, a plurality of location fingerprints, wherein each location fingerprint identifies and is associated with a respective geographic location and is based on cellular signal characteristics determined at the respective geographic location, the cellular signal characteristics including multiple channel impulse responses (CIRs) for each location fingerprint for signals received from a plurality of cellular nodes by one or more devices located at the respective geographic location; and
forming, by the at least one processor, a fingerprint map that references the obtained location fingerprints and geographic locations associated with the obtained location fingerprints, wherein forming the fingerprint map includes combining a subset of the obtained location fingerprints that are geographically proximate into one or more representative location fingerprints stored in association with one or more representative locations in the fingerprint map instead of the subset of the location fingerprints,
wherein the location fingerprints in the fingerprint map are comparable to a particular location fingerprint generated for a particular geographic location of a particular user device to determine the particular geographic location.

3. The computer-implemented method of claim 2, wherein the multiple CIRs are time synchronized based on:
being collected by a device simultaneously from the plurality of cellular nodes; or
being collected by the device at different times from the plurality of cellular nodes and being adjusted for clock drift.

4. The computer-implemented method of claim 2, further comprising:
receiving a request for determination of the particular geographic location of the particular user device;
obtaining, by the at least one processor, a particular location fingerprint generated for the particular user device that indicates particular cellular signal characteristics determined at the particular geographic location, the particular cellular signal characteristics including particular CIRs for particular signals received from multiple cellular nodes by the particular user device located at the particular geographic location;
comparing, by the at least one processor, the particular location fingerprint to multiple respective location fingerprints in the fingerprint map associated with a geographic area that includes the particular geographic location;
selecting, by the at least one processor, a matching location fingerprint of the multiple respective location fingerprints in the fingerprint map based on the comparing; and
causing, by the at least one processor, a geographic location associated with the matching location fingerprint to be output as the particular geographic location of the particular user device.

5. The computer-implemented method of claim 2, wherein obtaining the plurality of location fingerprints includes obtaining identifications of the plurality of cellular nodes that have been determined to be time synchronized in output of cellular signals from the plurality of cellular nodes.

6. The computer-implemented method of claim 2, wherein forming the fingerprint map that references the generated location fingerprints comprises:
combining a subset of the location fingerprints that are geographically proximate into a representative location fingerprint stored in association with a representative location in the fingerprint map instead of the subset of the location fingerprints.

7. The computer-implemented method of claim 6, wherein combining the subset of the location fingerprints comprises:
forming a plurality of clusters of location fingerprints, wherein the location fingerprints within each cluster are associated with respective locations that are within a threshold distance and each cluster is associated with a cluster location, and obtaining the representative location fingerprint for each cluster of the plurality of clusters by aggregating the location fingerprints within the cluster;
averaging the subset of the location fingerprints that are located within a threshold distance of each other to obtain the representative location fingerprint; or
averaging the subset of the location fingerprints based on a Gaussian process.

8. The computer-implemented method of claim 6, further comprising, prior to combining the subset of the location fingerprints, aligning, by the at least one processor, CIR data received from each of the plurality of cellular nodes, wherein the aligning compensates for a respective clock bias of the CIR data from the plurality of cellular nodes measured at different times.

9. The computer-implemented method of claim 2, wherein forming the fingerprint map comprises excluding one or more of the plurality of location fingerprints at the respective geographic location that are associated with CIRs that do not meet one or more threshold signal characteristics.

10. The computer-implemented method of claim 2, wherein forming the fingerprint map comprises:
identifying a plurality of reference geographic areas that each include a subset of the geographic locations;
determining an area representative fingerprint for each of the plurality of reference geographic areas based on a subset of the plurality of location fingerprints associated with the subset of the geographic locations; and
storing each of the plurality of location fingerprints as a difference between the location fingerprint and the area representative fingerprint.

11. A system comprising:
a processor; and
a memory coupled to the processor, with instructions stored thereon that, when executed by the processor, cause the processor to perform operations comprising:
receiving a request for determination of a particular geographic location of a particular user device;
obtaining a particular location fingerprint generated for the particular user device that indicates particular cellular signal characteristics determined at the particular geographic location, the particular cellular signal characteristics including particular CIRs for particular signals received from multiple cellular nodes by the particular user device located at the particular geographic location;
comparing the particular location fingerprint to multiple respective location fingerprints stored in a fingerprint map;
selecting a matching location fingerprint of the multiple respective location fingerprints in the fingerprint map based on the comparing; and
causing a respective geographic location associated with the matching location fingerprint to be output as the particular geographic location of the particular user device.

12. The system of claim 11, wherein the particular CIRs are time synchronized based on:
being collected by a device simultaneously from the multiple cellular nodes; or
being collected by the device at different times from the multiple cellular nodes and being adjusted for clock drift.

13. The system of claim 11, wherein the multiple respective location fingerprints are associated with a geographic area that includes the particular geographic location, and wherein the operation of determining the multiple respective location fingerprints in the fingerprint map comprises:
receiving an approximate geographic location of the particular user device and determining the geographic area based on a confidence level for an accuracy of the approximate geographic location.

14. The system of claim 11, wherein the operation of comparing comprises:
obtaining a plurality of versions of the particular location fingerprint by applying a respective linear offset to the particular location fingerprint to generate each respective version; and
comparing each of the plurality of versions of the particular location fingerprint to the multiple respective location fingerprints in the fingerprint map to obtain a plurality of correlation values, wherein each correlation value of the plurality of correlation values corresponds to a respective correlation of a version of the plurality of versions and a specific location fingerprint of the multiple respective location fingerprints.

15. The system of claim 14, wherein the operation of selecting the matching location fingerprint comprises selecting a matched location fingerprint of the multiple respective location fingerprints that provides the highest correlation value.

16. The system of claim 11, wherein the operation of comparing includes using a Fast Fourier Transform (FFT)-based correlation technique to determine correlations between the particular location fingerprint and the multiple respective location fingerprints, wherein the matching location fingerprint has a maximum correlation with the particular location fingerprint.

17. The system of claim 11, wherein the operation of selecting the matching location fingerprint includes determining an offset in samples of one of: the particular CIRs of the particular location fingerprint or the CIR of the matching location fingerprint that maximizes a correlation between the particular location fingerprint and the matching location fingerprint.

18. The system of claim 11, wherein the particular location fingerprint generated for the particular user device includes synchronized CIR data, wherein synchronization of the synchronized CIR data compensates for a respective clock bias of CIR data from the multiple cellular nodes measured at different times.

19. The system of claim 11, wherein the operations further comprise:
obtaining a plurality of location fingerprints, wherein each location fingerprint identifies and is associated with a respective geographic location and is based on cellular signal characteristics determined at the respective geographic location, the cellular signal characteristics including multiple channel impulse responses (CIRs) for each location fingerprint for signals received from a plurality of cellular nodes by one or more devices located at the respective geographic location; and
forming the fingerprint map that stores the obtained location fingerprints and geographic locations associated with the obtained location fingerprints, wherein forming the fingerprint map includes combining a subset of the obtained location fingerprints that are geographically proximate into one or more representative location fingerprints stored in association with one or more representative locations in the fingerprint map instead of the subset of the location fingerprints.

20. The system of claim 11, wherein the operations further comprise:
obtaining a plurality of location fingerprints, wherein each location fingerprint identifies and is associated with a respective geographic location and is based on cellular signal characteristics determined at the respective geographic location, the cellular signal characteristics including multiple channel impulse responses (CIRs) for each location fingerprint for signals received from a plurality of cellular nodes by one or more devices located at the respective geographic location; and
forming the fingerprint map that that stores the obtained location fingerprints and geographic locations associated with the obtained location fingerprints, wherein forming the fingerprint map includes, for each respective geographic location:
extracting one or more features from the multiple CIRs associated with the geographic location, wherein the one or more features are selected from a group of: signal energy, signal peaks, differential time of arrival, overlap energy, differential energy ratio, delay spread, statistical moments of the multiple CIRs, and combinations thereof;
forming a feature vector from the one or more features; and
storing the feature vector in the fingerprint map as the location fingerprint in association with the geographic location.
